(19) United States
(12) Patent Application Publication
(10) Pub. No.: US 2026/0253186 A1
(43) Pub. Date: Aug. 27, 2026

(54) ADVANCED FRAMEWORK FOR SIMULATING AND CORRECTING GENERATIVE INPAINTING ARTIFACTS

(71) Applicant: Adobe Inc., San Jose, CA (US)

(72) Inventors: Haitian Zheng, Rochester, NY (US); Jianming Zhang, Campbell, CA (US); Jingwan Lu, Santa Clara, CA (US); Sohrab Amirghodsi, Seattle, WA (US); Yuqian Zhou, Seattle, WA (US); Krishna Kumar Singh, San Jose, CA (US); Zhe Lin, Fremont, CA (US)

(21) Appl. No.: 19/065,753

(22) Filed: Feb. 27, 2025

(51) Int. Cl. G06T 5/77; G06T 5/50; G06T 5/60; G06T 7/11; G06T 7/194; G06T 11/00

(52) U.S. Cl. CPC G06T 5/77; G06T 5/50; G06T 5/60; G06T 7/11; G06T 7/194; G06T 11/00; G06T 2207/10024; G06T 2207/20081; G06T 2207/20084; G06T 2207/20212

(57) ABSTRACT

The present disclosure relates to systems, methods, and non-transitory computer-readable media that generates a refined digital image that corrects inpainting artifacts in a modified digital image with inpainted pixels. Furthermore, the disclosed systems receive an inpainting request to inpaint a region in a digital image (e.g., a region indicated by a mask). Moreover, the disclosed systems generate a modified digital image from the inpainting request and the digital image, where the modified digital image includes one or more inpainted portions in place of the region. Further, the disclosed systems use a neural network-based refiner model to generate a refined digital image from the modified digital image that corrects artifacts around borders of the one or more inpainted portions in the modified digital image.

### BACKGROUND

Recent years have seen significant advancement in hardware and software platforms for performing generative tasks. Indeed, systems provide a variety of ways to modify digital images by inpainting new pixels within a digital image. For instance, systems use generative models to remove an object of interest within a digital image and replace the object with new pixel values. Despite the advances in generative models performing inpainting tasks, systems suffer from a number of deficiencies with regards to accuracy and efficiency.

### SUMMARY

One or more embodiments described herein provide benefits and/or solve one or more problems in the art with systems, methods, and non-transitory computer-readable media that enhance the visual quality of inpainted images and also optimize the efficiency of generative inpainting tasks. To illustrate, in one or more embodiments, disclosed systems effectively identify inpainting artifacts in a modified digital image and generate a refined digital image that corrects artifacts in the modified digital image. Specifically, the disclosed systems utilize a generative inpainting model (e.g., an inpainting diffusion model) to generate a modified digital image from the digital image. Further, the disclosed systems generate a refined digital image from the modified digital image by using a neural network-based refiner model to correct inpainting artifacts present in the modified digital image.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a inpainting artifact correction system operates in accordance with one or more implementations;

FIG. 2 illustrates an overview of the inpainting artifact correction system correcting inpainting artifacts in a modified digital image by using a neural network-based refiner model in accordance with one or more implementations;

FIG. 3 illustrates an example diagram of the inpainting artifact correction system generating a refined digital image from a modified digital image in accordance with one or more implementations;

FIG. 4 illustrates an example diagram of the inpainting artifact correction system simulating inpainting artifacts to optimize parameters of a neural network-based refiner model in accordance with one or more implementations;

FIG. 5 illustrates an example diagrams of the inpainting artifact correction system generating various measures of loss to modify parameters of a neural network-based refiner model in accordance with one or more implementations;

FIGS. 6A-6C illustrates an example diagram of the inpainting artifact correction system generating an inpainted digital image at inference time in accordance with one or more implementations;

FIG. 7 illustrates a schematic diagram of the inpainting artifact correction system in accordance with one or more implementations;

FIG. 8 illustrates a flowchart of a series of acts for generating a refined digital image in accordance with one or more implementations;

FIG. 9 illustrates an example of a guided diffusion model according to aspects of the present disclosure;

FIG. 10 shows an example of a U-Net according to aspects of the present disclosure;

FIG. 11 shows an example of a method for conditional media generation according to aspects of the present disclosure;

FIG. 12 shows a diffusion process according to aspects of the present disclosure;

FIG. 13 shows a flow diagram depicting an algorithm as a step-by-step procedure for training a machine-learning model according to aspects of the present disclosure;

FIG. 14 shows an example of a method for training a diffusion model according to aspects of the present disclosure;

FIG. 15 shows an example of a computing device according to aspects of the present disclosure; and

FIG. 16 shows an example of a inpainting artifact correction system apparatus according to aspects of the present disclosure.

### DETAILED DESCRIPTION

One or more embodiments described herein includes an inpainting artifact correction system that leverages a neural network-based refiner model to correct inpainting artifacts from a generative inpainting model (e.g., a diffusion inpainting model). In other words, the inpainting artifact correction system adjusts/corrects inpainted pixel artifacts created by a generative model by using a neural network-based refiner model. Specifically, the inpainting artifact correction system uses a neural network-based refiner model (e.g., a model that is trained on a color space transformation) to correct artifacts (e.g., boundary cut-off, color shifting, texture mismatches, or noise pattern mismatches) by mapping the inpainted pixels to new pixel values (determined by the neural network-based refiner model).

As mentioned above, inpainted digital images often contain a variety of artifacts such as boundary cut-offs, color shifting, texture mismatches, or noise pattern mismatches. To learn how to correct such artifacts, the inpainting artifact correction system creates images with the inpainting artifacts (e.g., using an inpainting model) and pairs the images with inpainting artifacts with a corresponding ground truth image. In other words, the inpainting artifact correction system uses an advanced data augmentation scheme to train a neural network-based refiner model to modify/adjust pixel values in an inpainted image to reduce/eliminate inpainting artifacts that are commonly generated by generative models (such as diffusion models).

As mentioned above, in one or more embodiments, the inpainting artifact correction system uses a color space transformation at training time to optimize a neural network-based refiner model. Specifically, the inpainting artifact correction system generates a color tune mapping function, which is used to map a refined digital image and a ground truth version of the digital image to new pixel values. For instance, the inpainting artifact correction system generates transformed versions of the refined digital image and the ground truth image according to a color tune mapping function. In particular, the transformed versions allow the inpainting artifact correction system to capture subtle and nuanced differences and helps the inpainting artifact correction system to optimize parameters of the neural network-based refiner model.

As mentioned above, existing systems suffer from a number of issues relating to computational accuracy and efficiency. Specifically, existing systems suffer from computational inaccuracies. For example, for generative inpainting tasks, existing systems generate digital images with pixels that are inconsistent to background pixels. For instance, existing systems generate inpainted images with boundary cut-offs, color shifts, noise pattern mismatches, and texture mismatches.

In part, existing systems generate inaccurate images due to their inability to capture subtle color and texture differences (e.g., existing systems generate digital images with inpainted pixels that lack fine details and perceptual inaccuracies). Often, existing systems perform generative tasks and generate images that contain color shifts, subtle texture pattern mismatches, and other artifacts that make the generated digital image look distorted. To the human eye, the distortions are even more jarring. Thus, because existing systems fail to account for the subtle color and texture differences in digital images, this results in existing systems creating images that are unrealistic and unnatural.

In other words, existing systems use training tactics that capture broad features in images but often miss subtle and nuanced differences portrayed in those images. As a result, when performing inpainting tasks, existing systems fail to match the precise color and texture in realistic portrayals of those images. Despite existing systems making many advances in performing generative tasks, existing systems generate inpainted pixels that appear distorted or inaccurate.

Moreover, in some embodiments, existing systems suffer from inefficiencies when generating inpainted pixels. Specifically, due to the inaccurate training methods discussed above, existing systems typically require additional inputs, processing, and feedback at implementation time. For example, at inference time, existing system typically generate a sub-par result when performing generative tasks. Moreover, because existing systems typically generate a sub-par result for inpainted pixels within a digital image, existing systems also receive additional inputs to further edit the digital image. Thus, existing systems (at implementation time) consume additional time and computational resources to attempt to generate inpainted pixels.

In one or more embodiments, the inpainting artifact correction system provides several improvements over existing systems in relation to accuracy and efficiency. In contrast to existing systems which generate digital images with inpainted pixels that lack fine detail and perceptual accuracy, the inpainting artifact correction system generates subtle color and texture details when generating inpainted pixels in a digital image. Specifically, the inpainting artifact correction system manages to generate inpainted pixels that are realistically and accurately consistent with a remainder of a digital image by leveraging a neural network-based refiner model as part of its inpainting framework. To illustrate, the inpainting artifact correction system leverages the neural network-based refiner model to correct artifacts around borders of one or more inpainted portions in a modified digital image (e.g., containing inpainted pixels), thus fixing issues typically created by existing diffusion models (that perform inpainting tasks).

In one or more embodiments, the inpainting artifact correction system uses a specially curated image dataset (e.g., image data pairs with inpainting artifacts and ground truth images without inpainting artifacts) to optimize a neural network-based refiner model to generate high-quality images with inpainted pixels that are also without inpainting artifacts. In particular, rather than producing boundary cut-offs, color shifting, texture mismatches, or noise pattern mismatches, the inpainting artifact correction system generates parameters for training a neural network-based refiner model to accurately account for subtle and nuanced details (e.g., which subsequently results in the neural network-based refiner model correcting common inpainting deficiencies of diffusion inpainting models).

As mentioned above, existing systems often generate digital images with inpainting artifacts (e.g., color shifts, subtle texture pattern mismatches), however the inpainting artifact correction system implements the neural network-based refiner model in the inpainting framework to avoid these issues by accounting for the subtle details and nuances between a modified digital image and a ground truth image. In particular, the inpainting artifact correction system generates an amplified version of the modified digital image (e.g., the image with inpainted pixels) that indicates a color difference between the modified digital image and a ground truth version and further uses the amplified version to generate a color tune mapping function (e.g., which is used to train a neural network-based refiner model to accurately correct inpainting artifacts).

Moreover, in one or more embodiments, the inpainting artifact correction system improves upon computational efficiency of existing systems. In contrast to existing systems which typically require additional inputs after generating inpainted pixels (e.g., in a modified digital image), at implementation time, the inpainting artifact correction system generates a satisfactory image with inpainted pixels without a client device prompting and re-prompting the system (e.g., by fine-tuning a generated output from an inpainting model using the neural network-based refiner model). In particular, as mentioned above, the inpainting artifact correction system adds a neural network-based refiner model to an inpainting framework for generating inpainting pixels to correct generated artifacts from a diffusion inpainting model.

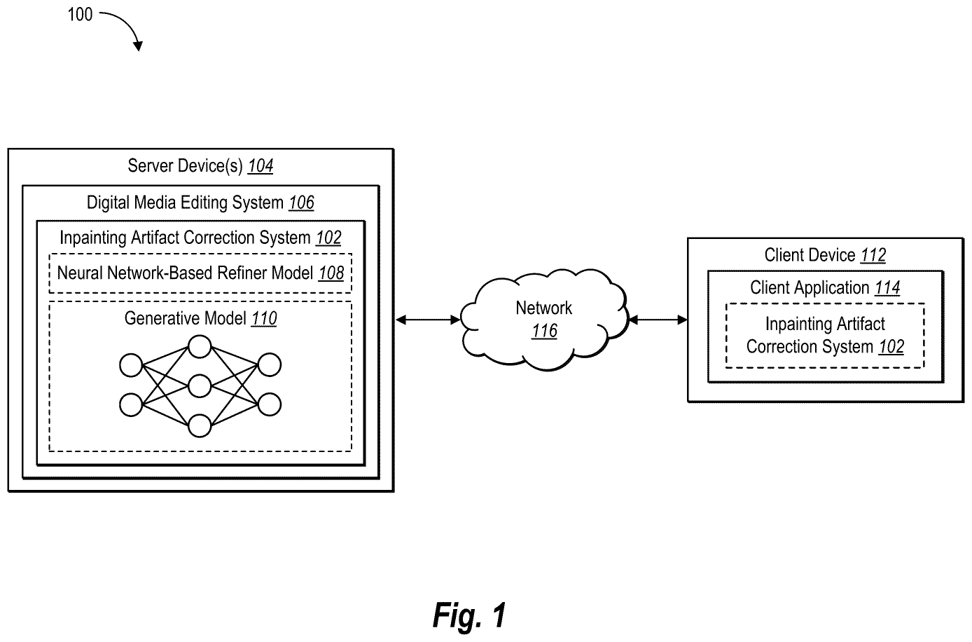

Additional details regarding the inpainting artifact correction system will now be provided with reference to the figures. For example, FIG. 1 illustrates a schematic diagram of an exemplary system environment 100 in which a inpainting artifact correction system 102 operates. As illustrated in FIG. 1, the system environment 100 includes server device(s) 104, a digital media editing system 106, a network 116, and a client device 112. Additionally, FIG. 1 illustrates that the digital media editing system 106 includes the inpainting artifact correction system 102, which includes a neural network-based refiner model 108 and a generative model 110. Moreover, the client device 112 includes a client application 114 (e.g., a client side digital media editing application).

Although the system environment 100 of FIG. 1 is depicted as having a particular number of components, the system environment 100 is capable of having a different number of additional or alternative components (e.g., a different number of server devices, client devices, or other components in communication with the inpainting artifact correction system 102 via the network 116). Similarly, although FIG. 1 illustrates a particular arrangement of the server device(s) 104, the network 116, and the client device 112, various additional arrangements are possible.

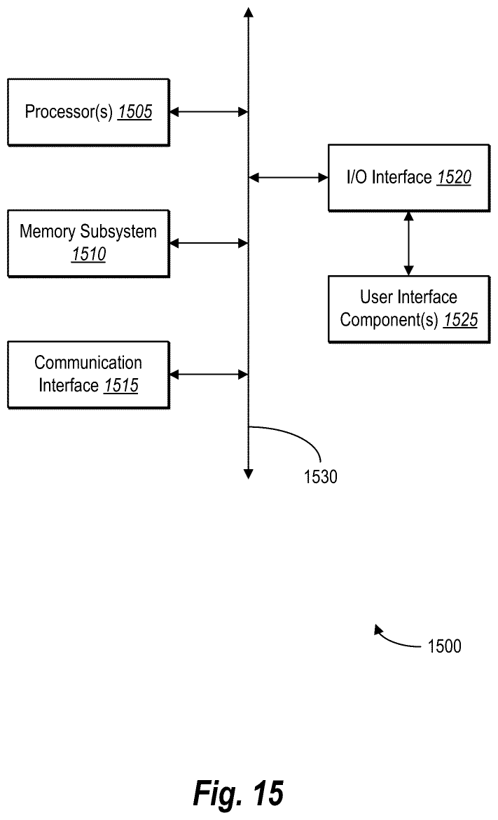

The server device(s) 104 and the client device 112 are communicatively coupled with each other either directly or indirectly (e.g., through the network 116 discussed in greater detail below in relation to FIG. 15). Moreover, the server device(s) 104 and the client device 112 include one or more of a variety of computing devices (including one or more computing devices as discussed in greater detail in relation to FIG. 15).

As mentioned above, the system environment 100 includes the server device(s) 104. In one or more embodiments, the server device(s) 104 process input for generating inpainted pixels in a digital image (e.g., by employing one or more models such as the neural network-based refiner model 108, the generative model 110 and/or a segmentation model). In one or more embodiments, the server device(s) 104 comprise a data server. In some implementations, the server device(s) 104 comprise a communication server or a web-hosting server.

In some embodiments, the client device 112 is associated with the one or more user accounts that submit requests to generate inpainted digital images. In one or more embodiments, the client device 112 includes smartphones, tablets, desktop computers, laptop computers, head-mounted-display devices, or other electronic devices. The client device 112 includes one or more software applications (e.g., the client application 114) for generating or modifying digital images in accordance with the digital media editing 106. In one or more embodiments, the client application 114 includes a software application hosted on the server device(s) 104 accessible by the client device 112 through another application, such as a web browser.

To provide an example implementation, in some embodiments, the digital media editing system 106 on the server device(s) 104 supports the client application 112 on the client device 112. For instance, in some cases, the inpainting artifact correction system 102 on the server device(s) 104 trains the neural network-based refiner model 108 utilizing an adaptive color tune transformation loss. In response, the inpainting artifact correction system, via the server device(s) 104, provides the trained the neural network-based refiner model 108 to the client device 112. In other words, the client device 112 obtains (e.g., downloads) the neural network-based refiner model 108 from the server device(s) 104 that is already trained/optimized utilizing an adaptive color tune transformation loss. Once downloaded, the neural network-based refiner model 108 on the client device 112 is able to perform refine digital images generated by the generative model 110 independent from the server device(s) 104. In one or more alternative implementations, the inpainting artifact correction system 102 generates or learns parameters for the neural network-based refiner model 108 in whole or in part on the client device 112.

In alternative implementations, the digital media editing system 106 includes a web hosting application that allows the client device 112 to interact with content and services hosted on the server device(s) 104. To illustrate, in one or more implementations, the client device 112 accesses a software application supported by the server device(s) 104. In response, the digital media editing system 106 on the server device(s) 104 provides tools for performing image inpainting or other image editing or creation tasks. In other words, the client device 112 does not have to download the inpainting artifact correction system 102, the neural network-based refiner model 108, or the generative model 110 while still being able to access/utilize the trained/optimized tools provided by digital media editing system 106 via a web hosting application.

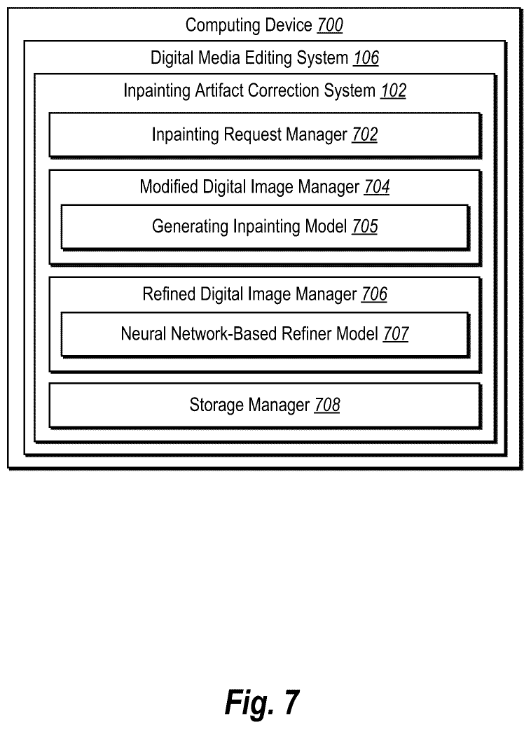

In some embodiments, the inpainting artifact correction system 102 is implemented in whole, or in part, by the individual elements of the system environment 100. For instance, although FIG. 1 illustrates the inpainting artifact correction system 102 implemented or hosted on the server device(s) 104, different components of the inpainting artifact correction system 102 are able to be implemented by a variety of devices within the system environment 100. For example, one or more (or all) components of the inpainting artifact correction system 102 are implemented by a different computing device or a separate server from the server device(s) 104. Indeed, as shown in FIG. 1, the client device 112 includes the inpainting artifact correction system 102. Example components of the inpainting artifact correction system 102 will be described below with regard to FIG. 7.

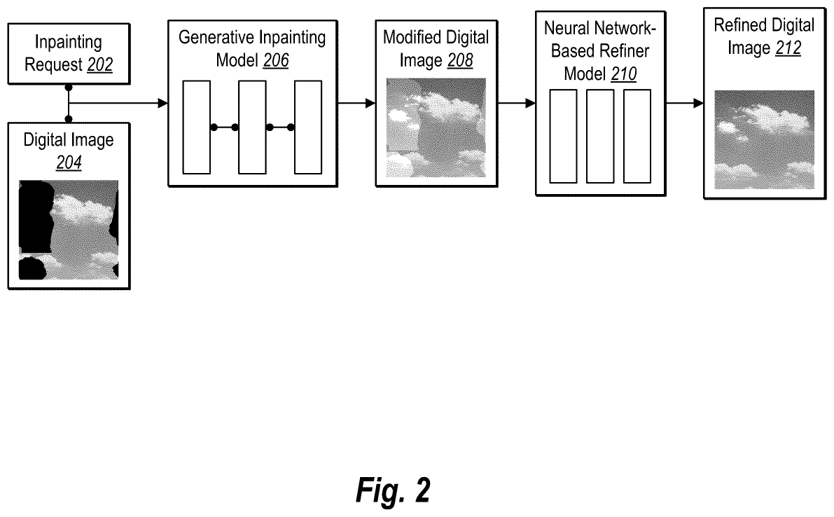

As mentioned above, at inference time, the inpainting artifact correction system 102 uses a neural network-based refiner model to correct inpainting artifacts in a modified digital image. FIG. 2 illustrates an overview diagram of the inpainting artifact correction system 102 that generates a refined digital image (e.g., refined relative to a modified digital image) in accordance with one or more embodiments. For example, FIG. 2 shows the inpainting artifact correction system 102 receiving an inpainting request 202 that includes a digital image 204.

In one or more embodiments, the inpainting artifact correction system 102 receives the inpainting request 202 from a client device. For example, the inpainting artifact correction system 102 receives the inpainting request 202 that includes the digital image 204 and a prompt to modify one or more aspects of the digital image 204. Specifically, the inpainting artifact correction system 102 determines infill modifications for the digital image 204 based on the inpainting request 202 (e.g., prompt) received from the client device. For instance, the infill modification includes infilling a region or inpainting the region of the digital image 204. In one or more embodiments, the inpainting request 202 includes a request to add pixel values and/or replace pixel values with new pixel values. Accordingly, the inpainting request 202 includes a request to add pixel values to a digital image to either fill a gap or to replace a region/object depicted within the digital image 204.

In one or more embodiments, the inpainting artifact correction system 102 receives or accesses the digital image 204 as part of the inpainting request 202. In one or more embodiments, the digital image 204 includes a digital frame composed of various pictorial elements. In particular, the pictorial elements include pixel values that define the spatial and visual aspects of the digital image 204. Furthermore, the inpainting artifact correction system 102 receives digital images from various image editing platforms.

As further illustrated, the inpainting artifact correction system 102 uses a generative inpainting model 206 to generate a modified digital image 208 (e.g., modified relative to the digital image 204). In one or more embodiments, the modified digital image 208 refers to a digital image that has been changed, altered, or enhanced by a generative model. In particular, the modified digital image 208 refers to a digital image that includes one or more inpainted portions in place of one or more regions in the digital image 204. Further, the inpainting artifact correction system 102 utilizes the generative inpainting model 206 to replace the one or more regions with inpainted portions. Moreover, in some embodiments, the modified digital image 208 contains inpainting artifacts. Specifically, the modified digital image contains inpainting artifacts around borders of one or more inpainted portions in the modified digital image.

Furthermore, as shown, the inpainting artifact correction system 102 uses a neural network-based refiner model 210 to correct the inpainting artifacts in the modified digital image 208 and generate a refined digital image 212. In one or more embodiments, the refined digital image 212 refers to a digital image with modified/altered pixel values relative to the modified digital image 208. Specifically, the inpainting artifact correction system 102 corrects artifacts within the modified digital image 208 to generate the refined digital image 212. In one or more embodiments, the inpainting artifact correction system 102 processes the modified digital image 208 with the neural network-based refiner model 210 to map pixel values in the modified digital image 208 to new pixel values.

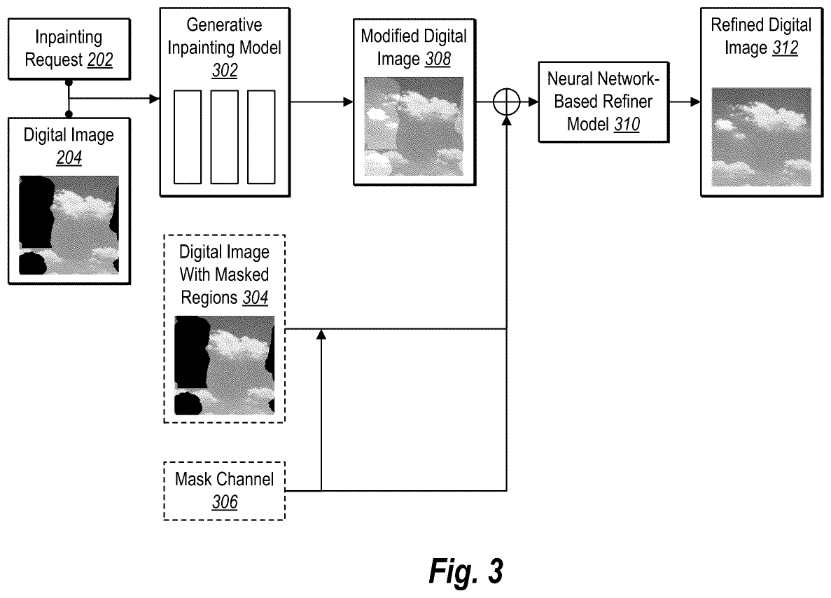

As mentioned above, the inpainting artifact correction system 102 combines the modified digital image with one or more additional data inputs to generate a refined digital image. FIG. 3 illustrates the inpainting artifact correction system 102 generating a refined digital image from a modified digital image and at least one of a mask channel or a digital image with a masked region in accordance with one or more embodiments. For example, FIG. 3 shows the inpainting artifact correction system 102 using a generative inpainting model 302 to generate a modified digital image 308.

In one or more embodiments, the generative inpainting model 302 is a machine learning model. Specifically, a machine learning model includes a computer algorithm or a collection of computer algorithms that are trained and/or tuned based on inputs to approximate unknown functions. For example, a machine learning model includes a computer algorithm with branches, weights, or parameters that changed based on training data to improve for a particular task. Thus, a machine learning model utilizes one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

In one or more embodiments, the inpainting artifact correction system 102 uses a diffusion neural network as the generative inpainting model 302. In particular, (to prepare/initiate a diffusion neural network) a diffusion neural network receives as input a digital image and adds noise to the digital image through a series of steps. In one or more embodiments, the inpainting artifact correction system 102 via the diffusion neural network maps a digital image to a latent space utilizing a fixed Markov chain that adds noise to the data of the digital image. Specifically, each step of the fixed Markov chain relies upon the previous step, and at each step, the fixed Markov chain adds Gaussian noise with variance which produces a diffusion representation (e.g., diffusion latent vector, a diffusion noise map, or a diffusion inversion).

Subsequent to adding noise to the digital image at various steps of the diffusion neural network, the inpainting artifact correction system 102 utilizes a denoising neural network to recover the original data from the digital image. Specifically, the inpainting artifact correction system 102 utilizes a denoising neural network with a length T equal to the length of the fixed Markov chain to reverse the process of the fixed Markov chain. In particular, the denoising neural network reconstructs the digital image without the masked portion and replaces the masked portion with inpainted pixels that conform with the remainder of the digital image. In other words, the inpainting artifact correction system 102 trains the denoising neural network to remove noised data and replace the noised data with inpainted pixels. Accordingly, after training, the inpainting artifact correction system 102 implements a trained diffusion neural network to generate inpainted pixels.

As mentioned above, the inpainting artifact correction system 102 generates inpainted pixels for a digital image based on a region in the digital image being indicated by a mask or some other input (e.g., a digital sketch) from user input via a client device. In one or more embodiments, the region indicated in the digital image includes a portion of an initial digital image to modify. In some instances, the region includes one or more objects within the digital image. In one or more embodiments, an object includes a collection of pixels in a digital image that depicts a person, place, or thing. In particular, in some embodiments, an object includes a person, an item, a natural object (e.g., a tree or rock formation) or a structure depicted in a digital image.

Moreover, in some instances, an object refers to a plurality of elements that, collectively, are distinguished from other elements depicted in a digital image. For example, in some instances, an object includes a collection of buildings that make up a skyline. In some instances, an object more broadly includes a (portion of a) foreground or other element(s) depicted in a digital image as distinguished from a background.

As mentioned above, in some embodiments, a client device indicates a region in a digital image via a mask. Specifically, the client device indicates a region, the inpainting artifact correction system 102 masks the region, and further uses the generative inpainting model 302 to modify pixels in the masked region. In one or more embodiments, the inpainting artifact correction system 102 receives a sketch from a client device over the digital image. Specifically, the inpainting artifact correction system 102 receives input from the client device that traces over a specific region (e.g., object, such as a car) in the digital image. From the input (e.g., the digital sketch) from the client device, the inpainting artifact correction system 102 further generates the digital image with a mask corresponding to the portion indicated by the digital sketch.

In one or more embodiments, the inpainting artifact correction system 102 generates masks for the region (e.g., human, object, or a background portion of the digital image). In particular, the inpainting artifact correction system 102 generates the mask by segmenting a portion of the digital image based on a portion of the digital image indicated by user input via a client device. In one or more embodiments, the inpainting artifact correction system 102 generates a mask by utilizing a convolutional operation of a segmentation machine learning model to generate a mask corresponding to an indicated region (e.g., the object or the background).

In one or more embodiments, the inpainting artifact correction system 102 utilizes a segmentation neural network to assign a label to various pixels within the digital image. Specifically, the inpainting artifact correction system 102 assigns labels to every pixel within the digital image. For instance, the inpainting artifact correction system 102 assigns a label to pixels in a manner that groups pixels together that share certain characteristics (e.g., background portion, a foreground portion, or any portion of the digital image indicated by a client device). To illustrate, the inpainting artifact correction system 102 segments the digital image to assist generative models in locating objects and boundaries within the digital image.

As mentioned above, the inpainting artifact correction system 102 utilizes neural networks. For example, the inpainting artifact correction system 102 utilizes a segmentation neural network. In particular, the segmentation neural network receives an input digital image and further receives a specific indication within the digital image (e.g., as indicated by a sketch/input from user input via a client device) and generates encodings for each pixel value within the digital image and/or the digital sketch from the user input via the client device. Based on the encodings, the segmentation neural network generates a segmented digital image (e.g., the digital image with a mask).

As shown in FIG. 3, in one or more embodiments, the inpainting artifact correction system 102 utilizes the generative inpainting model 302 to generate the modified digital image 308. Specifically, the inpainting artifact correction system 102 uses the generative inpainting model (e.g., diffusion neural network) to generate the modified digital image 308, which contains an infill modification. In one or more embodiments, the infill modification includes inpainting modifications. In particular, the infill modification includes the inpainting artifact correction system 102 adding pixel values to a region or replacing pixel values. For replacing pixel values, the inpainting artifact correction system 102 replaces existing pixel values in a digital image with new pixel values. In other words, the infill modification modifies existing pixels within the digital image. As just mentioned, infill modification also includes inpainting modifications. In one or more embodiments, inpainting includes replacing/adjusting pixel values within a digital image to be consistent with a remainder of the details/texture of the digital image. In particular, inpainting includes replacing/adjusting currently existing pixel values within the digital image.

As used herein the term “pixel value” refers to an addressable element in a raster image represented by one or more numerical values. In particular, a pixel value is an element of a picture represented on a display screen and the pixel value describes the brightness of the pixel and a color of the pixel. For example, a pixel includes RGB pixel values between 0 and 255.

Furthermore, FIG. 3 shows the inpainting artifact correction system 102 further using a neural network-based refiner model 310 to generate a refined digital image 312. Specifically, in one or more embodiments, FIG. 3 shows the inpainting artifact correction system 102 combining the modified digital image 308 with at least one of the digital image with masked regions 304 or the mask channel 306 to generate the refined digital image 312.

In one or more embodiments, the digital image with one or more regions masked 304 refers to a digital image with a mask applied to region(s) of interest in the digital image. Specifically, the inpainting artifact correction system 102 effectively masks out the one or more region in the digital image corresponding to the mask. In one or more embodiments, if the inpainting artifact correction system 102 receives input to replace a human object with inpainted pixels, the inpainting artifact correction system 102 further masks the human object in the digital image. Accordingly, the digital image with one or more regions masked contains the object of interest (e.g., the human object) filtered or hidden.

In one or more embodiments, the mask channel 306 refers to a channel used to represent pixels or elements within the digital image that contains the mask (e.g., binary mask). Specifically, the mask channel 306 indicates which pixels/elements within the digital image should be considered, manipulated, or ignored during generative tasks (e.g., inpainting). In addition to specific color channels (e.g., RGB channels), the inpainting artifact correction system 102 utilizes an additional mask channel that holds values such as 0s and 1s to indicate which pixels should be active or inactive.

As mentioned above, the inpainting artifact correction system 102 uses the neural network-based refiner model to generate the refined digital image 312. In particular, the inpainting artifact correction system 102 uses a generative adversarial networks (GAN) as the neural network-based refiner model, which is trained on a color space transformation discussed in more detail below. In one or more embodiments, for initiating/training a GAN, two machine learning models compete with each other in a zero-sum game.

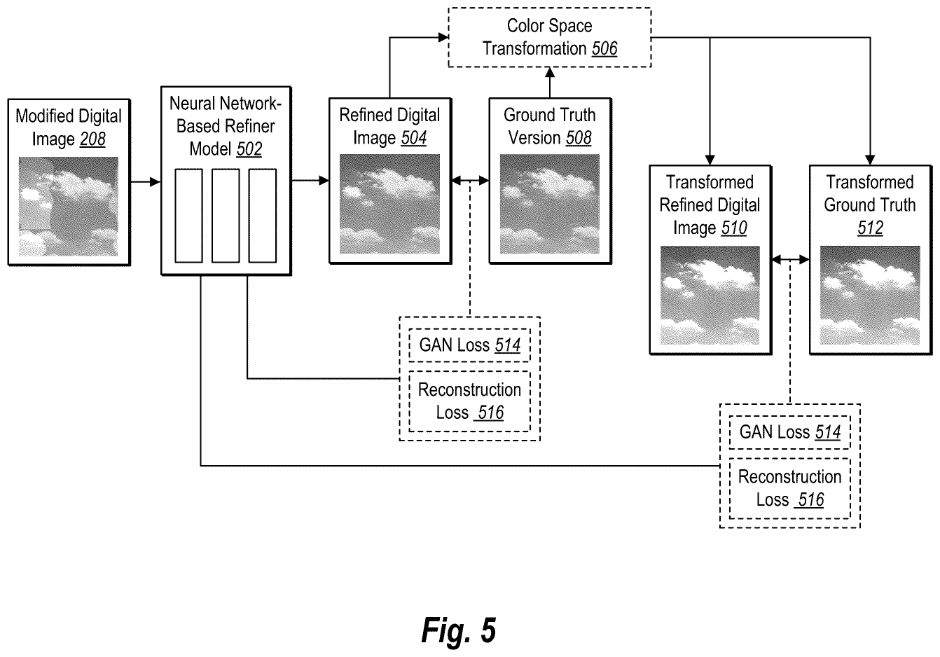

To illustrate, the generative aspect of the machine learning model generates features for which a discriminator makes an authenticity prediction of the generated feature. If the generative neural network manages to generate a feature in which the discriminator is unable to discriminate as unauthentic (e.g., tricks the discriminator), the discriminator loss is propagated back to the discriminator for modification of the discriminator's parameters. If the generative neural network is unable to “trick” the discriminator, then the measure of loss (the generative machine learning model being unable to trick the discriminator) is propagated back to the generative machine learning model for modification of the generative machine learning model's parameters. Thus, the inpainting artifact correction system 102 progressively refines parameters of the neural network-based refiner model using principles of a GAN and further refines the parameters using a color space transformation discussed below in FIG. 5.

At inference time, the inpainting artifact correction system 102 utilizes the generator of the GAN (e.g., the neural network-based refiner model 310) to generate the refined digital image 312. For instance, the inpainting artifact correction system 102 utilizes the generator of the GAN to process the modified digital image 308 (e.g., which contains inpainted pixels and inpainting artifacts) and produces additional data (e.g., the refined digital image 312). To illustrate, the generator portion of the GAN at inference time contains various downsampling layers such as an input layer, intermediate layers, and a final layer. In one or more embodiments, the input layer processes a latent vector along with conditioning information (e.g., the modified digital image 308, the mask channel 306, digital image with masked regions 304) and transforms the latent vector into a higher-dimensional feature map.

In other words, the inpainting artifact correction system 102 utilizes the generator portion of the GAN as a hierarchical encoder (e.g., a multi-channel encoder to process the modified digital image 308 and a combination of at least one of the digital image with masked regions 304 or the mask channel 306, such that the multi-channel encoder has up to 7 channels, 3 for the modified digital image 308, 3 for the digital image with masked regions 304, and 1 for the mask channel 306). As mentioned, each layer of the plurality of layers corresponds with a different image resolution. In particular, downsampling includes moving from the full digital image resolution (e.g., 256×512) and moving one resolution lower. Furthermore, for downsampling, the inpainting artifact correction system 102 also utilizes skip connections to a corresponding layers.

In one or more embodiments, the generator portion of the GAN does not contain upsampling layers (e.g., upsampling includes moving from a lower resolution for a digital image to a higher resolution) but includes downsampling layers to generate inpainted pixels with reduced or no inpainting artifacts in the refined digital image 312. Specifically, the inpainting artifact correction system 102 receives the modified digital image 308 at a specific image resolution and uses the GAN (trained on a color space transformation) to generate the refined digital image 312 at the same image resolution. In other words, the inpainting artifact correction system 102 utilizes the GAN to adjust the texture and color inside a masked region of a digital image corresponding to the modified digital image 308 to match the surrounding color and texture in the digital image.

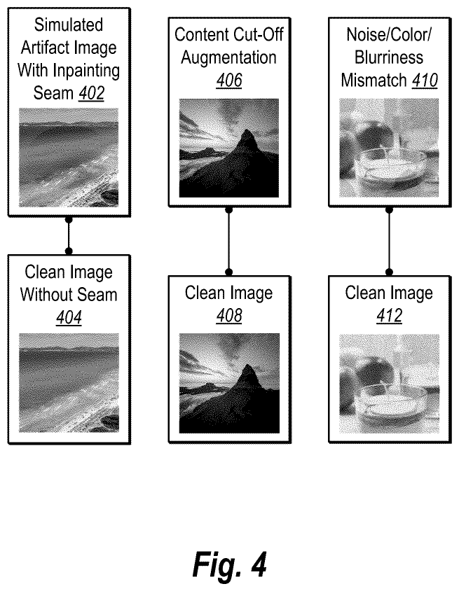

As mentioned above, the inpainting artifact correction system 102 uses an advanced data augmentation scheme to train/optimize a neural network-based refiner model to accurately correct deficiencies in inpainting models. FIG. 4 illustrates the inpainting artifact correction system 102 simulating inpainting artifacts and pairing the images with inpainting artifacts with corresponding ground truth images (e.g., with completed/clean regions).

As shown in FIG. 4, the inpainting artifact correction system 102 generates a simulated artifact image with an inpainting seam 402. Further, FIG. 4 shows the inpainting artifact correction system 102 pairing the simulated artifact image with the inpainting seam 402 with a clean image 404 without the inpainting seam. Moreover, FIG. 4 shows the inpainting artifact correction system 102 generating a content cut-off augmentation 406 and pairing that with a clean image 408. Additionally, FIG. 4 shows the inpainting artifact correction system 102 generating a mismatch 410 of noise, color, and/or blurriness in a digital image and pairing that digital image with a clean image 412.

As just mentioned, the inpainting artifact correction system 102 generates a variety of images with different inpainting artifacts. In one or more embodiments, a boundary cut-off refers to visual distortions in a digital image that occur near a boundary or edge of an image or processed regions of an image. Specifically, boundary cut-off includes a loss of detail near or at the boundary of processed regions in an image. For instance, the boundary cut-off includes blurry portions of a digital image, pixelated portions, or otherwise distorted regions. To illustrate, as mentioned above, the modified digital images include artifacts such as boundary cut-off which takes the form of sharp or unnatural edges, blurry or missing content, or discontinuities portrayed within the digital image.

In one or more embodiments, color shifting refers to a perceptible change or alteration in colors of a digital image that deviates from an expected or initial color representation of the digital image. Specifically, the color shifting includes noticeable changes in hue, saturation, or brightness that is inconsistent with the rest of the digital image. To illustrate, a hue shift includes an overall alteration in the hue of the image (e.g., reds become more orange, or blues become greener), a saturation shift (e.g., colors appear more or less vibrant than intended), and a brightness or lightness shift (e.g., the overall lightness or darkness of colors changes, which leads to an image that appears lighter or darker than expected).

In one or more embodiments, texture mismatches refer to visible distortions or inconsistencies in the digital image regarding an appearance of texture. Specifically, the patterns, details or surface qualities depicted in a digital image appear distorted or inconsistent with one another. As such, texture mismatches typically result in unnatural transitions or visible seams within the digital image.

In one or more embodiments, noise pattern mismatches refer to a visible distortion or inconsistency in a digital image caused by noise pattern discrepancies. Specifically, noise pattern mismatches refer to grain, random pixel variations, or distorted patterns in a digital image that result in a non-uniform-distribution across the digital image. In one or more embodiments, the digital image contains different types of noise or compression artifacts that vary across the image and give the image a distorted appearance.

In one or more embodiments, the inpainting artifact correction system 102 optimizes/trains the neural network-based refiner model by using paired data images. Specifically, the paired data images include a digital image with inpainting artifacts (e.g., the inpainting seam 402, the content cut-off augmentation 406, and the mismatch 410) and a ground truth of the digital image that does not include inpainting artifacts (e.g., clean images). In one or more embodiments, the inpainting artifact correction system 102 uses the paired data images to generate refined digital images (e.g., digital images that attempt to eliminate/reduce inpainting artifacts of the digital image with inpainting artifacts) and further compares the refined digital image with the ground truth version.

In one or more embodiments, a ground truth digital image refers to an image that is considered true or a reference image. Specifically, a ground truth digital image refers to a digital image without inpainting artifacts and acts as a reference image for comparing to an inpainted digital image. In one or more embodiments, the ground truth digital image represents an accurate or ideal state of a digital image.

In one or more embodiments, the inpainting artifact correction system 102 simulates the augmentations/perturbations in the digital images by using a separate inpainting model (e.g., a generative inpainting model different than generative inpainting model 302) for generating inpainted pixels. Specifically, the inpainting artifact correction system 102 applies an inpainting model on a boundary of a clean image (e.g., no augmentations/perturbations). In doing so, the inpainting artifact correction system 102 generates an inpainted digital image (e.g., with augmentations/perturbations) and further combines the background pixels from the initial digital image with the inpainted digital image. Furthermore, the inpainting artifact correction system 102 accesses the clean image as a ground truth reference.

In one or more embodiments, the inpainting artifact correction system 102 simulates sensor noise data by using a inpainting model to generate inpainted pixels from a digital image. Specifically, the inpainting artifact correction system 102 uses the inpainting model to apply a first noise pattern and noise level inside a hole (e.g., outside a masked region) and a second noise pattern and second noise level outside a hole (e.g., within a masked region).

In one or more embodiments, the inpainting artifact correction system 102 simulates JPEG artifacts by using a first compression method for inside a hole (e.g., within a masked region) and a second compression method for outside a hole (e.g., outside the masked region). In doing so, the inpainting artifact correction system 102 generates a digital image with JPEG artifacts. In one or more embodiments, the inpainting artifact correction system 102 generates non-local color augmentations. Specifically, the inpainting artifact correction system 102 uses a random alpha blending channel (e.g., a uniform alpha blending channel, a linear alpha blending channel, or a non-local alpha blending channel) to blend a digital image and generate a new image that has different color values than the initial image. Moreover, in some embodiments, the color difference generated by the inpainting artifact correction system 102 is non-uniform (e.g., a linear augmentation). In some embodiments, the color difference generated by the inpainting artifact correction system 102 is uniform.

In some embodiments, the inpainting artifact correction system 102 uses random ellipses (e.g., a non-local color augmentation that is an ellipses that is lighter on the inner part and darker on the outer part) to distort the color values within a digital image. Specifically, the inpainting artifact correction system 102 pastes (e.g., combines) the random ellipses with the digital image to perturb the color values of the image. In other words, the inpainting artifact correction system 102 generates digital images with a first color inside a masked region and a second color outside the masked region (e.g., the pixel values outside the masked region are background pixels) and the color values inside and outside the masked region are different.

In one or more embodiments, the inpainting artifact correction system 102 uses Gaussian blurring to make the texture of a digital image blurrier inside a masked region and the texture outside of the masked region less blurry. In doing so, the inpainting artifact correction system 102 simulates a texture difference. Further, in some embodiments, the inpainting artifact correction system 102 utilizes various combinations of the above-discussed augmentations/perturbations to teach a generative model to fix/alter pixel values of perturbed images.

As mentioned above, the inpainting artifact correction system 102 uses a color space transformation to train a neural network-based refiner model for more accurately correcting inpainting artifacts in an inpainted digital image (e.g., modified digital image). For example, FIG. 5 shows the inpainting artifact correction system 102 using a neural network-based refiner model 502 to correct inpainting artifacts in a digital image (e.g., modified digital image) to generate a refined digital image 504. Specifically, FIG. 5 shows the inpainting artifact correction system 102 comparing the refined digital image 504 with a ground truth version 508 of the digital image (e.g., the ground truth version 508 is accessed by the inpainting artifact correction system 102 and contains unpainted pixel values and is completed relative to the refined digital image 504 and a modified digital image with inpainted pixels).

Furthermore, in one or more embodiments, FIG. 5 shows the inpainting artifact correction system 102 generating measures of loss from comparing the refined digital image 504 and the ground truth version 508. In one or more embodiments, a measure of loss refers to a mathematical function that quantifies a difference between a generated output (e.g., generated by the neural network-based refiner model, such as a GAN) and a ground truth value. Specifically, a measure of loss provides a way to assess how well or poorly a generative model's predictions align with expected or ground truth values. Moreover, the inpainting artifact correction system 102 uses the measure of loss to optimize/train the neural network-based refiner model 502 to minimize a loss function, which leads to better performance of refining inpainted pixel values.

FIG. 5 illustrates the inpainting artifact correction system 102 generating a GAN loss 514 and a reconstruction loss 516 for the comparison between the refined digital image 504 and the ground truth version 508. In one or more embodiments, reconstruction loss refers to a measure of the degree of closeness for a decoder output to the original output. Specifically, in some embodiments, the inpainting artifact correction system 102 utilizes a mean-squared error to determine the reconstruction loss. In other words, the reconstruction loss measures a fidelity between the original (initial) digital image and a newly generated digital image. Furthermore, a partial reconstruction loss measures the fidelity between only the reconstructed part in the generated image that exists within the original digital image. In some embodiments, the inpainting artifact correction system 102 uses an L1 or L2 loss as the reconstruction loss. In one or more embodiments, L1 loss refers to mean absolute error loss used for image-based tasks. Specifically, L1 loss measures the absolute differences between the predicted values and the ground truth values. In contrast with L2 loss (e.g., mean squared error), L1 loss is less sensitive to outliers and use useful for image reconstruction tasks.

As mentioned previously, a discriminator and GAN attempt to generate a realistic-looking digital image. In one or more embodiments, the inpainting artifact correction system 102 determines adversarial loss (e.g., GAN loss) for a generative model (e.g., the neural network-based refiner model 502). In particular, the adversarial loss includes the GAN and discriminator attempting to trick one another in a zero-sum game. Specifically, the GAN attempts to train the generator to produce realistic data, while the discriminator tries to distinguish between real data and fake data. Based on the adversarial loss, the inpainting artifact correctio system 102 fine tunes the neural network-based refiner model 502 to generate realistic-looking digital images.

Furthermore, the GAN loss involves one for the generator and one for the discriminator. For instance, the inpainting artifact correction system 102 utilizes a binary cross-entropy loss to classify whether a given input is real or fake (e.g., the discriminator is encouraged to correctly classify fake data as fake) and the generator loss is designed to encourage the generator to generate data that maximizes the probability of being classified as real by the discriminator. Moreover, the inpainting artifact correction system 102 uses a total GAN loss, which is a sum of the generator loss and the discriminator loss.

In addition to the GAN loss and the reconstruction loss, in some embodiments, the inpainting artifact correction system 102 uses a perceptual loss. In one or more embodiments, perceptual loss refers to a comparison of high-level features between a generated image (e.g., refined digital image) and a ground truth digital image. Specifically, a perceptual loss involves comparing activations or feature maps of various layers of the neural network-based refiner model against feature maps of ground truth images (e.g., rather than comparing pixel values directly). For instance, a perceptual loss aims to capture perceptually meaningful differences between images, rather than being limited to pixel-wise differences.

Additionally, as mentioned above, the inpainting artifact correction system 102 further uses a color space transformation 506 to train the neural network-based refiner model 502. For example, the inpainting artifact correction system 102 uses the color space transformation 506 to generate transformed versions of the refined digital image 504 and the ground truth version 508.

In one or more embodiments, the inpainting artifact correction system 102 uses the color space transformation 506 to generate a color tune mapping function. Specifically, the inpainting artifact correction system 102 uses the color space transformation model which is specifically tailored for capturing/enhancing subtle and nuance differences between the refined digital image 504 and a ground truth version 508 of a digital image.

In one or more embodiments, the inpainting artifact correction system 102 generates a color tune mapping function to further generate transformed versions of digital images. Specifically, a color tune mapping function refers to a mathematical or algorithmic process to map pixel values of a digital image to specific color values. In one or more embodiments, the inpainting artifact correction system 102 utilizes a color tune mapping function to enhance the underlying data points by making the patterns in the digital image more visually distinguishable.

To generate the color tune mapping function, the inpainting artifact correction system 102 initially generates an amplified version of the refined digital image 504. Specifically, the inpainting artifact correction system 102 applies a color difference enhancement to the refined digital image 504 to generate the amplified version of the refined digital image 504. For instance, the inpainting artifact correction system 102 determines a difference in pixel values of the refined digital image 504 and the ground truth version 508 of the digital image.

Further, the inpainting artifact correction system 102 enhances the difference in pixel values of the refined digital image 504 and the ground truth version 508 by a preset value (e.g., beta). Specifically, beta refers to a preset value that is confined within a preset range (e.g., [20, 40]). To illustrate, the inpainting artifact correction system 102 amplifies the color difference by a beta of 20.

Moreover, the inpainting artifact correction system 102 combines the enhanced difference in color values with the ground truth version 508 to generate the amplified version of the refined digital image 504. In particular, the amplified version of the refined digital image 504 indicates a color difference between the refined digital image 504 and the ground truth version 508 of the digital image.

In one or more embodiments, the inpainting artifact correction system 102 further uses the amplified version of the refined digital image 504 to generate the color tune mapping function. Specifically, the inpainting artifact correction system 102 samples sets of pixels from the refined digital image 504 and the amplified version of the refined digital image 504. For instance, the inpainting artifact correction system 102 samples a first set of pixel values from the refined digital image 504 and a second set of pixel values from the amplified version of the refined digital image 504.

Furthermore, the inpainting artifact correction system 102 evenly samples from inside a mask region and from outside a mask region (e.g., as indicated in a digital image to generate inpainted pixels in a modified digital images) of the refined digital image and the amplified version of the refined digital image 504. For example, the inpainting artifact correction system 102 samples a first subset outside of a mask region of the refined digital image 504, a second subset inside a mask region of the refined digital image 504, a third subset outside a mask region of the amplified version of the refined digital image 504, and a fourth subset inside a mask region of the amplified version of the refined digital image 504.

In one or more embodiments, the inpainting artifact correction system 102 uses x-values and y-values obtained from sampling from the amplified version of the refined digital image 504 and the refined digital image 504 to generate a color tune mapping function. For example, the inpainting artifact correction system 102 uses the set of pixel values sampled from the refined digital image 504 as x-values. Further, the inpainting artifact correction system 102 uses the set of pixel values sampled from the amplified version of the refined digital image 504 as y-values. Furthermore, the inpainting artifact correction system 102 takes the x-values and the y-values and runs a polynomial regression to generate the color tune mapping function. In one or more embodiments, a polynomial regression refers to a type of analysis where the relationship between the x-values and the y-values is modeled as a nth-degree polynomial.

In other words, a polynomial regression captures non-linear trends, where a higher degree (for a polynomial function) captures more complex curves. To illustrate, the inpainting artifact correction system 102 uses a degree of six for the polynomial regression. Moreover, the inpainting artifact correction system 102 uses the polynomial regression to generate the color map tuning function by using a fitted polynomial equation (e.g., the captured non-linear trends) to make predictions on new input values (e.g., new pixel values corresponding to the refined digital images and ground truth digital images).

As shown in FIG. 5, the inpainting artifact correction system 102 uses the color space transformation 506 to generate a transformed refined digital image 510 and a transformed ground truth image 512. In one or more embodiments, the transformed refined digital image 510 refers to the inpainting artifact correction system 102 mapping pixel values of the refined digital image 504 to new pixel values. Specifically, the transformed refined digital image 510 refers to a digital image that is mapped to different pixel values based on a color tune mapping function. In one or more embodiments, the inpainting artifact correction system 102 uses the transformed refined digital image 510 to better capture perceptual differences (e.g., nuance and subtle differences) in a digital image to teach the neural network-based refiner model 502 to better generate digital images without inpainting artifacts.

In one or more embodiments, the transformed ground truth image 512 of the digital image refers to the inpainting artifact correction system 102 mapping pixel values of the ground truth version to new pixel values. Specifically, the transformed ground truth image 512 is mapped to different pixel based on the color tune mapping function. Similar to the transformed refined digital image 510, the inpainting artifact correction system 102 uses the transformed ground truth image 512 to more accurately determine a measure of loss between the transformed refined digital image 510 and a ground truth reference. In essence, inpainting artifact correction system 102 amplifies or highlights more subtle perceptual differences between the refined digital image 504 and the ground truth version 508 of the digital image by generating the transformed refined digital image 510 and the transformed ground truth image 512.

In one or more embodiments, the inpainting artifact correction system 102 utilizes the following algorithm to perform the color space transformation as described above:

Step 1: perform a color difference enhancement: amplified version of refined digital image =
ground truth image + beta * (refined digital image − ground truth image).
Step 2: evenly sample pixel values from the refined digital image and the amplified version of
the refined digital image, such that pixels are sampled from inside and outside the hole (e.g., a
masked region), to make the data point balanced.
Step 3: take sampled pixel values from the refined digital image as x and take the sampled
pixel values from the amplified version of the refined digital image as y, run a polynomial
regression (degree=6, differentiable) to generate the color tune mapping function.
Step 4: run this color tune mapping function on the refined digital image and the ground truth
image, to generate a transformed refined digital image and a transformed ground truth image.

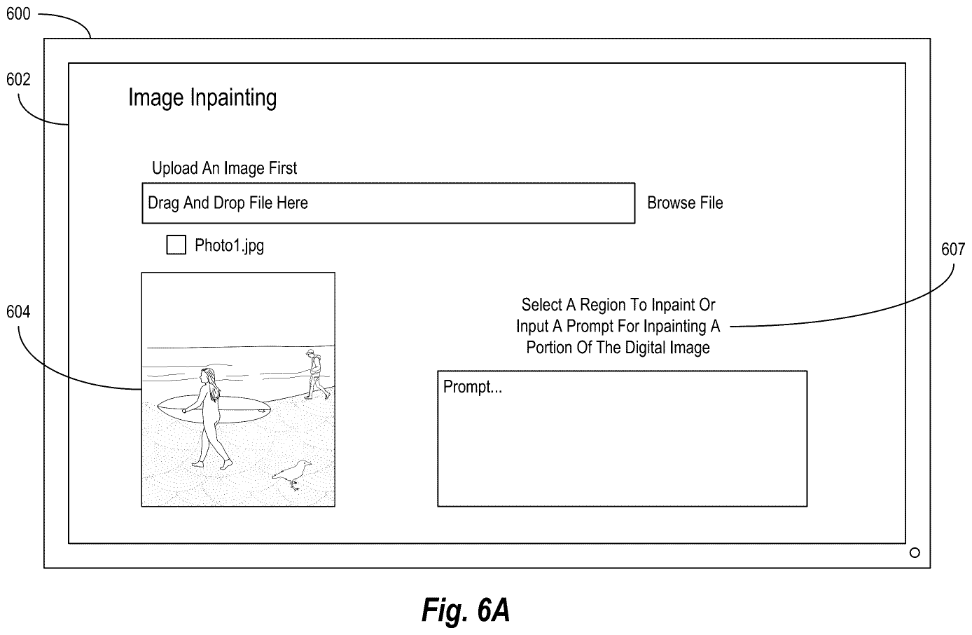

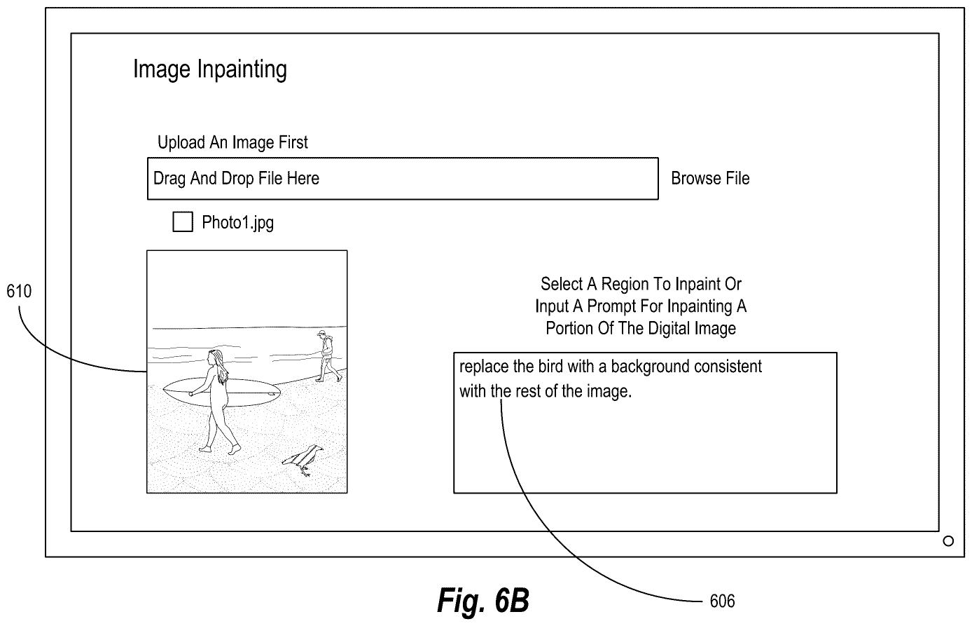

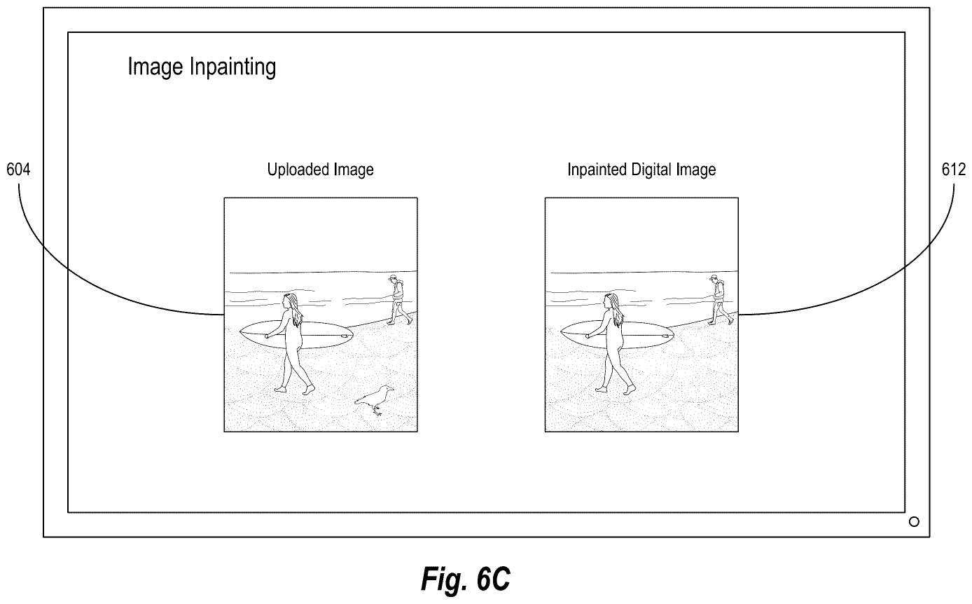

FIG. 6A illustrates a graphical user interface 602 of a client device 600 at which the client device submits inpainting requests. Specifically, FIG. 6A shows an option to upload an image and further shows the inpainting artifact correction system 102 receiving an upload of digital image 604. Moreover, FIG. 6A shows an option for the client device 600 to submit a prompt and/or to further perform an act 607 of selecting a region to inpaint in the digital image 604. In one or more embodiments, the inpainting artifact correction system 102 receives a digital sketch or input from the client device 600 (e.g., via a drawing tool) that indicates a portion of the digital image 604.

FIG. 6B illustrates the inpainting artifact correction system 102 receiving an input from the client device 600 that includes a digital sketch/outline around the bird portrayed in the digital image 604. Moreover, FIG. 6B shows the inpainting artifact correction system 102 receiving a prompt from the client device 600. In particular, the inpainting artifact correction system 102 receives the prompt 606 of “replace the bird with a background consistent with the rest of the image.” Although FIG. 6B shows both a masked digital image 610 (e.g., the bird is masked) and the prompt 606 describing the inpainting task, in one or more embodiments, the inpainting artifact correction system 102 receives either the masked digital image 610 or the prompt 606.

Furthermore, in some embodiments, if the inpainting task is described in just the prompt 606, the inpainting artifact correction system 102 utilizes a segmentation model to segment a portion of the digital image. In particular, the inpainting artifact correction system 102 utilizes a segmentation neural network to assign a label to various pixels within the digital image 604, as described above.

FIG. 6C illustrates the inpainting artifact correction system 102 generating an inpainted digital image 612 from the digital image 604. Specifically, FIG. 6C shows a result of the inpainting artifact correction system 102 utilizing a neural network-based refiner model (trained on the color space transformation) to generate the inpainted digital image 612 that reduces/avoids generating inpainted pixels with inpainting artifacts. In one or more embodiments, the inpainting artifact correction system 102 generates the inpainted digital image 612 by using an inpainting framework that includes a generative inpainting model (e.g., a diffusion neural network) and further includes the neural network-based refiner model. In particular, the inpainting artifact correction system 102 generates an initial digital image with inpainted pixels (e.g., modified digital image) and then corrects the initial digital image with inpainted pixels using the neural network-based refiner model.

Turning to FIG. 7, additional detail will now be provided regarding various components and capabilities of the inpainting artifact correction system 102. In particular, FIG. 7 illustrates an example schematic diagram of a computing device 700 (e.g., the server device(s) 104 and/or the client device 112) implementing the inpainting artifact correction system 102 in accordance with one or more embodiments of the present disclosure for components 700-708. As illustrated in FIG. 7, the inpainting artifact correction system 102 includes a inpainting request manager 702, a modified digital image manager 704, a generative inpainting model 705, a refined digital image manager 706, a neural network-based refiner model 707, and a storage manager 708.

The inpainting request manager 702 receives one or more requests from a client device. Specifically, the inpainting request manager 702 receives a request to modify pixels within a digital image. For instance, the inpainting request manager 702 receives a request to inpaint a region within a digital image, where the request indicates the region via a mask. Furthermore, the inpainting request manager 702 provides a variety of tools for a client device to indicate regions/areas within a digital image for the inpainting artifact correction system 102 to inpaint.

The modified digital image manager 704 generates a modified digital image from a digital image. For example, the modified digital image manager 704 receives a digital image with an indicated region within the digital image. Specifically, the modified digital image manager 704 receives the digital image and a masked region within the digital image, for which the modified digital image manager 704 inpaints within the masked region. For instance, the modified digital image manager 704 employs the generative inpainting model 705 to generate inpainted pixels to conform with the remainder of the digital image. Furthermore, in some embodiments, the modified digital image manager 704 accounts for text prompt instructions included as part of a inpainting request to generate the modified digital image. Moreover, the modified digital image manager 704 works hand in hand with the generative inpainting model 705 to perform one or more generative tasks. In some instances, the generative inpainting model 705 is a diffusion model.

The refined digital image manager 706 generates a refined digital image. Specifically, the refined digital image manager 706 operates as part of an inpainting framework to correct defects from the generative inpainting model 705 generating inpainting artifacts. For example, the refined digital image manager 706 receives the modified digital image (e.g., with inpainted pixels) and fixes/adjusts pixel values within the modified digital image. For instance, the refined digital image manager 706 corrects artifacts around borders of inpainted portions in the modified digital image by leveraging the neural network-based refiner model 707. In some instances, the neural network-based refiner model 707 is a generative adversarial neural network.

The storage manager 708 stores various components discussed in FIG. 7. For example, the storage manager 708 stores the generative inpainting model 705, the neural network-based refiner model 707, digital images, modified digital images, refined digital images, training data (e.g., image data pairs), ground truth images, measures of loss, a color space transformation, amplified versions of digital images, and transformed versions of digital images.

Each of the components 700-708 of the inpainting artifact correction system 102 include software, hardware, or both. For example, the components 700-708 include one or more instructions stored on a computer-readable storage medium and executable by processors of one or more computing devices, such as a client device or server device. When executed by the one or more processors, the computer-executable instructions of the inpainting artifact correction system 102 cause the computing device(s) to perform the methods described herein. Alternatively, the components 700-708 include hardware, such as a special-purpose processing device to perform a certain function or group of functions. Alternatively, the components 700-708 of the inpainting artifact correction system 102 include a combination of computer-executable instructions and hardware.

Furthermore, the components 700-708 of the inpainting artifact correction system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 700-708 of the inpainting artifact correction system 102 may be implemented as a stand-alone application, such as a desktop or mobile application. Furthermore, the components 700-708 of the inpainting artifact correction system 102 may be implemented as one or more web-based applications hosted on a remote server. Alternatively, or additionally, the components 700-708 of the inpainting artifact correction system 102 may be implemented in a suite of mobile device applications or “apps.” For example, in one or more embodiments, the inpainting artifact correction system 102 comprise or operate in connection with digital software applications such as ADOBE® PHOTOSHOP, ADOBE® PHOTOSHOP CC, ADOBE® PHOTOSHOP LIGHTROOM, and ADOBE® FIREFLY.

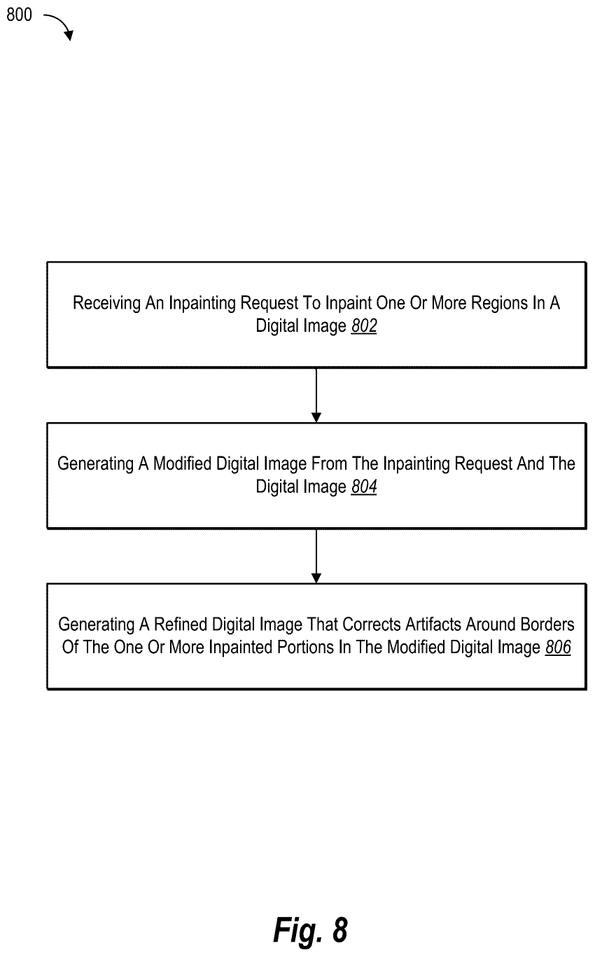

FIGS. 1-7, the corresponding text, and the examples provide a number of different methods, systems, devices, and non-transitory computer-readable media of the components 702-708. In addition to the foregoing, one or more embodiments are described in terms of flowcharts comprising acts for accomplishing the particular result. For example, FIG. 8 illustrates a flowchart of example sequences of acts in accordance with one or more embodiments.

FIG. 8 illustrates a flowchart of a series of acts 800 for generating a refined digital image that corrects inpainting artifacts in a modified digital image in accordance with one or more embodiments. FIG. 8 illustrates acts according to one embodiment, alternative embodiments may omit, add to, reorder, and/or modify any of the acts shown in FIG. 8. In some implementations, the acts of FIG. 8 are performed as part of a method. For example, in some embodiments, the acts of FIG. 8 are performed as part of a computer-implemented method. Alternatively, a non-transitory computer-readable medium stores instructions thereon that, when executed by at least one processor, cause a computing device to perform the acts of FIG. 8. In some embodiments, a system performs the acts of FIG. 8. For example, in one or more embodiments, a system includes at least one memory device. The system further includes at least one server device configured to cause the system to perform the acts of FIG. 8.

The series of acts 800 includes an act 802 of receiving an inpainting request to inpaint one or more regions in a digital image. Further, the series of acts 800 includes an act 804 of generating a modified digital image from the inpainting request and the digital image. Moreover, the series of acts 800 includes an act 806 of generating a refined digital image that corrects artifacts around borders of the one or more inpainted portions in the modified digital image.

In particular, the act 802 includes receiving an inpainting request to inpaint one or more regions in a digital image, wherein the one or more regions are indicated by a mask. Further, the act 804 includes generating, utilizing a generative inpainting model, a modified digital image from the inpainting request and the digital image that includes one or more inpainted portions in place of the one or more regions. Moreover, the act 806 includes generating, utilizing a neural network-based refiner model, a refined digital image that corrects artifacts around borders of the one or more inpainted portions in the modified digital image.

For example, in one or more embodiments, the series of acts 800 includes generating the modified digital image comprises replacing the one or more regions indicated by the mask with inpainted pixels that conform with a background of the digital image. In addition, in one or more embodiments, the series of acts 800 includes generating the modified digital image comprises generating inpainted pixels at the borders of the one or more inpainted portions with at least one of a boundary cut-off, color shifting, texture mismatches, or noise pattern mismatches. Further, in one or more embodiments, the series of acts 800 includes generating a combined image by combining the modified digital image, the digital image with the one or more regions masked, and a mask channel of the one or more regions. Further, in some embodiments, the series of acts 800 includes generating, utilizing a multi-channel encoder of the neural network-based refiner model, the refined digital image from the combined image by mapping inpainted pixels in the modified digital image to new pixel values.

Moreover, in one or more embodiments, the series of acts 800 includes training the neural network-based refiner model by accessing ground truth digital images without inpainting artifacts. Further, in one or more embodiments, the series of acts 800 includes generating digital images with inpainting artifacts from the ground truth digital images without inpainting artifacts. Moreover, in one or more embodiments, the series of acts 800 includes generating, utilizing the neural network-based refiner model, refined training digital images to compare with the ground truth digital images without inpainting artifacts. Further, in one or more embodiments, the series of acts 800 includes modifying parameters of the neural network-based refiner model based on a comparison of the refined training digital images with the ground truth digital images without inpainting artifacts.

Moreover, in one or more embodiments, the series of acts 800 includes training the neural network-based refiner model by generating, utilizing the generative inpainting model, a digital image with inpainting artifacts from a training digital image. Additionally, in one or more embodiments, the series of acts 800 includes generating, utilizing the neural network-based refiner model, a refined training digital image from the digital image with inpainting artifacts. In one or more embodiments, the series of acts 800 includes generating, utilizing a color space transformation model, a transformed version of the refined training digital image and a transformed version of a ground truth version of the training digital image.

Moreover, in one or more embodiments, series of acts 800 includes modifying parameters of the neural network-based refiner model based on comparing the refined training digital image with the ground truth version of the training digital image and comparing the transformed version of the refined training digital image with the transformed version of the ground truth version of the training digital image. For example, in one or more embodiments, the series of acts 800 includes receiving input from a client device that indicates the mask for the one or more regions to replace the one or more regions portrayed in the digital image with content consistent with a remainder of the digital image.

In addition, in one or more embodiments, the series of acts 800 includes receiving an inpainting request to inpaint a region in a digital image, the region indicated by a mask. Further, in one or more embodiments, the series of acts 800 includes generating, utilizing a generative inpainting model, a modified digital image from the inpainting request that includes inpainted pixels in the region indicated by the mask. Further, in some embodiments, the series of acts 800 includes generating, utilizing a neural network-based refiner model, a refined digital image that adjusts inpainting artifacts in the inpainted pixels around a border of the region in the modified digital image. Moreover, in some embodiments, the series of acts 800 includes generating the modified digital image that comprises inpainted pixels with at least one of a boundary cut-off, color shifting, texture mismatches, or noise pattern mismatches. In one or more embodiments, the series of acts 800 includes generating, utilizing the neural network-based refiner model, the refined digital image that corrects at least one of the boundary cut-off, color shifting, texture mismatches, or noise pattern mismatches by mapping the inpainted pixels to new pixel values.

Furthermore, in one or more embodiments, the series of acts 800 includes receiving, from a client device, a sketch over the digital image that comprises the mask of the region within the digital image. Moreover, in one or more embodiments, the series of acts 800 includes receiving, from the client device, an indication to replace the sketch of the mask of the region in the digital image with content consistent with pixels outside of the sketch of the mask in the digital image. Moreover, in one or more embodiments, the series of acts 800 includes generating the modified digital image utilizing a generative diffusion model by combining an intermediate digital image and the digital image with the region masked. Further, in one or more embodiments, the series of acts 800 includes generating a combined image by combining the modified digital image and at least one of the digital image with the region masked or a mask channel of the region. In one or more embodiments, the series of acts 800 includes generating, utilizing a multi-channel encoder of the neural network-based refiner model, the refined digital image from the combined image.

Moreover, in one or more embodiments, the series of acts 800 includes training the neural network-based refiner model by generating digital images with inpainting artifacts by perturbing digital images to include at least one of a boundary cut-off, color shifting, texture mismatches, or noise pattern mismatches. Further, in one or more embodiments, the series of acts 800 includes generating paired data images comprising ground truth digital images without inpainting artifacts and the digital images with inpainting artifacts. In one or more embodiments, the series of acts 800 includes generating, utilizing the neural network-based refiner model, refined training digital images from the digital images with inpainting artifacts.

Moreover, in some embodiments, the series of acts 800 includes comparing the refined training digital images with the ground truth digital images without inpainting artifacts. Further, in some embodiments, the series of acts 800 includes generating measures of loss based on comparing the refined training digital images with the ground truth digital images without inpainting artifacts. Moreover, in some embodiments, the series of acts 800 includes modifying parameters of the neural network-based refiner model based on the measures of loss.

Furthermore, in one or more embodiments, the series of acts 800 includes receiving an inpainting request to inpaint one or more regions in a digital image, wherein the one or more regions are indicated by a mask. Moreover, in one or more embodiments, the series of acts 800 includes generating, utilizing a generative inpainting model, a modified digital image from the inpainting request and the digital image that includes one or more inpainted portions in place of the one or more regions. Further, in one or more embodiments, the series of acts 800 includes generating, utilizing a neural network-based refiner model, a refined digital image from the modified digital image. For example, in one or more embodiments, the series of acts 800 includes generating, utilizing a color space transformation model, a transformed version of the refined digital image and a transformed version of a ground truth version of the digital image. In one or more embodiments, the series of acts 800 includes modifying parameters of the neural network-based refiner model based on comparing the refined digital image with the ground truth version of the digital image and comparing the transformed version of the refined digital image with the transformed version of the ground truth version of the digital image.

In addition, in one or more embodiments, the series of acts 800 includes applying perturbations to a set of digital images, wherein the perturbations comprise at least one of a boundary cut-off, color shifting, texture mismatches, or noise pattern mismatches. Further, in one or more embodiments, the series of acts 800 includes accessing ground truth versions of the set of digital images without perturbations applied. Further, in some embodiments, the series of acts 800 includes generating paired data images comprising the set of digital images and the ground truth versions of the set of digital images without perturbations applied, wherein the paired data images comprise the modified digital image and the ground truth version of the digital image.

Furthermore, in one or more embodiments, the series of acts 800 includes combining the modified digital image with a mask channel of the one or more regions in the digital image. Moreover, in one or more embodiments, the series of acts 800 includes generating, utilizing the neural network-based refiner model, the refined digital image that corrects artifacts around borders of the one or more regions in in the modified digital image. Further, in one or more embodiments, the series of acts 800 includes generating a first measure of reconstruction loss by comparing the refined digital image with the ground truth version of the digital image. Further, in some embodiments, the series of acts 800 includes modifying parameters of the neural network-based refiner model based on the first measure of reconstruction loss. Furthermore, in one or more embodiments, the series of acts 800 includes generating a second measure of reconstruction loss by comparing the transformed version of the refined digital image with the transformed version of the ground truth version of the digital image. Furthermore, in one or more embodiments, the series of acts 800 modifying parameters of the neural network-based refiner model based on the second measure of reconstruction loss.

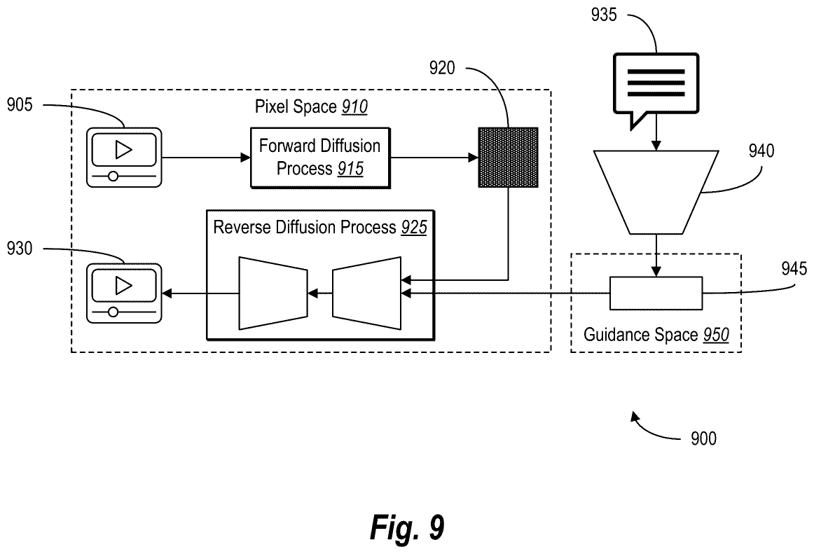

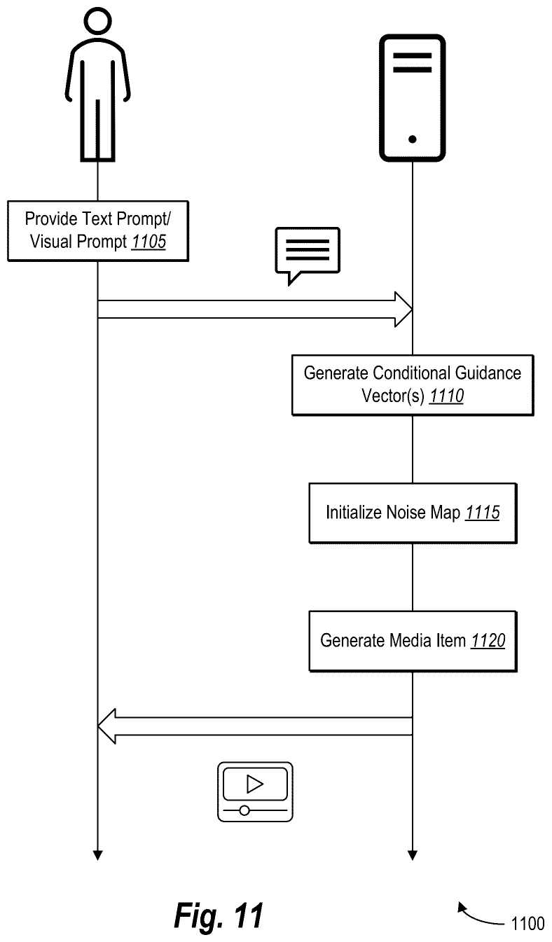

FIG. 9 shows an example of a diffusion model 900 according to aspects of the present disclosure. In some examples, a diffusion model 900 describes the operation and architecture of a generative diffusion model (e.g., diffusion inpainting model) described with reference to FIG. 11. The diffusion model 900 depicted in FIG. 9 is an example of, or includes aspects of, the inpainting artifact correction system 102 as described herein. Accordingly, FIG. 9 shows the inpainting artifact correction system 102 initializing a trained generative diffusion model by leveraging a forward diffusion process to destroy data and then creating media (e.g., inpainted pixels to replace a region in a digital image) from the destroyed data using a denoising process. In other words, the inpainting artifact correction system 102 teaches a generative diffusion model to create generative content from noise using a forward diffusion process and a denoising process.

As an example, diffusion models are generative models that operate by progressively destroying/noising an input signal and learning to reverse the destroyed data to generate new samples. In particular, diffusion models use a forward diffusion process to add noise over a series of timesteps and a reverse diffusion process to remove noise over a number of timesteps corresponding to the forward number of steps.

Next, a reverse diffusion process 925 (e.g., a U-Net) gradually removes the noise from a noisy media item 920 at the various noise levels to obtain an output media item 930. In some cases, an output media item 930 is created from each of the various noise levels. The output media item 930 can be compared to the original media item 905 to train the reverse diffusion process 925.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, image inpainting, and media manipulation.

Diffusion models work by iteratively adding noise to the data during a forward process and then learning to recover the data by denoising the data during a reverse process. For example, during training, a guided latent diffusion model may take an original media item 905 in a pixel space 910 as input and apply forward diffusion process 915 to gradually add noise to the original media item 905 to obtain noisy media item 920 at various noise levels.

The reverse diffusion process 925 can also be guided based on a text prompt 935 (e.g., inpainting request), or another guidance prompt, such as an image, a layout, a segmentation map, etc. The text prompt 935 can be encoded using a text encoder 940 (e.g., an encoder that can also be a multimodal encoder) to obtain guidance features 945 in guidance space 950. The guidance features 945 can be combined with the noisy media item at one or more layers of the reverse diffusion process 925 to ensure that the output media item 930 includes content described by the text prompt 935. For example, the guidance features 945 can be combined with the noisy features using a cross-attention block within the reverse diffusion process 925.

In one or more embodiments, methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

In one or more embodiments, the inpainting artifact correction system 102 utilizes a diffusion process to adds noise to data in the pixel space 910. Furthermore, FIG. 9 shows the inpainting artifact correction system 102 utilizing the forward diffusion process 915 to add noise to the data. Moreover, FIG. 9 shows the inpainting artifact correction system 102 utilizing a denoising process to remove noise from noised data. For instance, the inpainting artifact correction system 102 utilizes a decoder to generate the output media item 930. Further, in one or more embodiments, the inpainting artifact correction system 102 adds noise to data in a progressive manner (e.g., over a number of timesteps corresponding to a number of diffusion steps). In doing so, the inpainting artifact correction system 102 trains a diffusion model to create generative content from destroyed data (e.g., the noised data).

In one or more embodiments, the inpainting artifact correction system 102 uses a diffusion transformer model as the diffusion inpainting model. For instance, the inpainting artifact correction system 102 leverage the architecture of a transformer model to capture long-range dependencies and complex structures in high-dimensional data. Specifically, the diffusion transformer models operate by processing token data of images and text (e.g., text of an inpainting request) to fully consider the long-range dependencies. Moreover, the diffusion transformer model as the diffusion inpainting model use the transformer architecture to predict the denoised data at each timestep (e.g., transformer block), and uses a self-attention mechanism to the noised data to understand how noise should be removed across various noised input tokens.

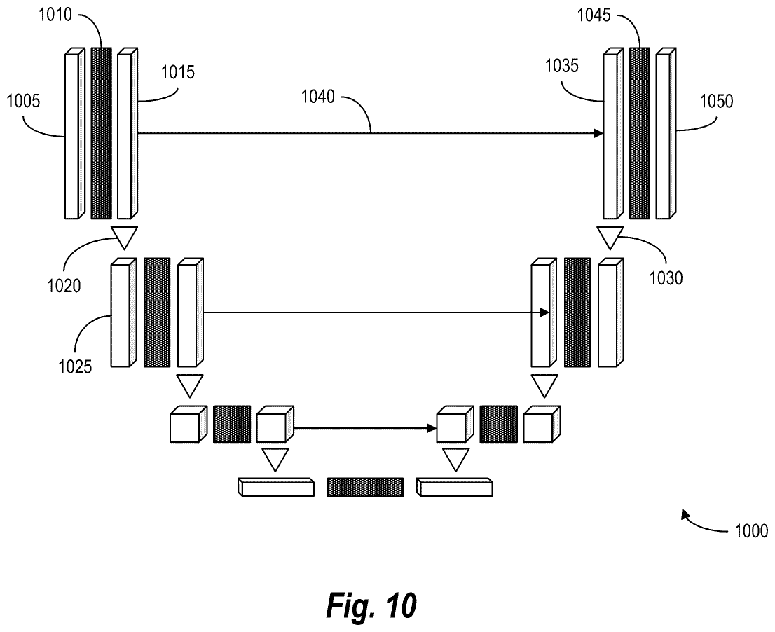

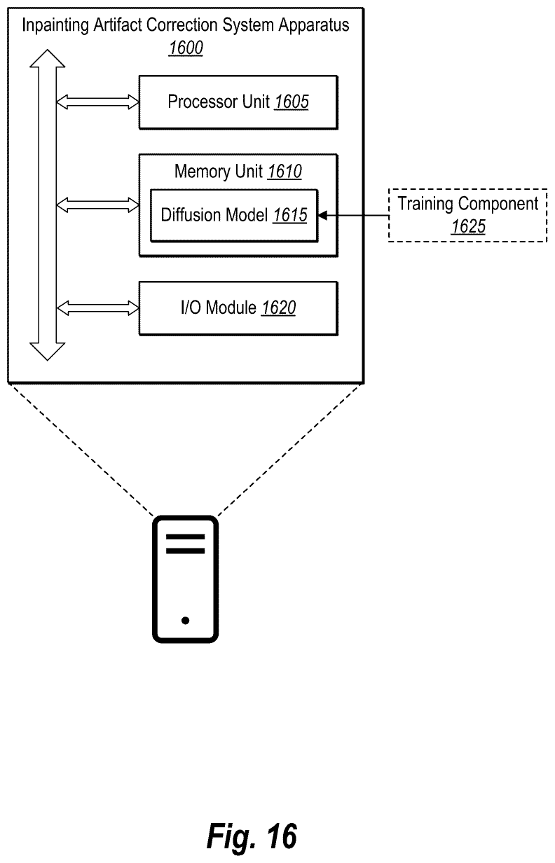

FIG. 10 shows an example of a U-Net 1000 according to aspects of the present disclosure. In some examples, U-Net 1000 is an example of the component that performs the reverse diffusion process 925 of the diffusion model 900 described with reference to FIG. 9 and includes architectural elements of the inpainting artifact correction system 102 described with reference to FIG. 16. The U-Net 1000 depicted in FIG. 10 is an example of, or includes aspects of, the architecture used within the reverse diffusion process described with reference to FIG. 9.

In some examples, diffusion models are based on a neural network architecture known as a U-Net. The U-Net 1000 takes input features 1005 having an initial resolution and an initial number of channels and processes the input features 1005 using an initial neural network layer 1010 (e.g., a convolutional network layer) to produce intermediate features 1015. The intermediate features 1015 are then down-sampled using a down-sampling layer 1020 such that the down-sampled features 1025 features have a resolution less than the initial resolution and a number of channels greater than the initial number of channels.

This process is repeated multiple times, and then the process is reversed. That is, the down-sampled features 1025 are up-sampled using up-sampling process 1030 to obtain up-sampled features 1035. The up-sampled features 1035 can be combined with intermediate features 1015 having the same resolution and number of channels via a skip connection 1040. These inputs are processed using a final neural network layer 1045 to produce output features 1050. In some cases, the output features 1050 have the same resolution as the initial resolution and the same number of channels as the initial number of channels.

In some cases, U-Net 1000 takes additional input features to produce conditionally generated output. For example, the additional input features could include a vector representation of an input prompt. The additional input features can be combined with the intermediate features 1015 within the neural network at one or more layers. For example, a cross-attention module can be used to combine the additional input features and the intermediate features 1015.

FIG. 11 shows an example of a method 1100 for media generation according to aspects of the present disclosure. In some examples, method 1100 describes an operation of the diffusion model such as an application of the diffusion model 900 described with reference to FIG. 9. In some examples, these operations are performed by a system including a processor executing a set of codes to control functional elements of an apparatus such as the inpainting artifact correction system 102 described above.

Additionally, or alternatively, steps of the method 1100 may be performed using special-purpose hardware. Generally, these operations are performed according to the methods and processes described in accordance with aspects of the present disclosure. In some cases, the operations described herein are composed of various substeps or are performed in conjunction with other operations.

At operation 1105, a user provides a text and/or visual prompt (e.g., an inpainting request) describing content to be included in a generated media item (e.g., guidance on how to inpaint pixels within a digital image). For example, a user may provide the prompt “remove the person playing with a cat”. In some examples, guidance can be provided in a form other than text, such as via an image (e.g., a visual prompt), a sketch, an audio input, or a layout.

At operation 1110, the system converts the text prompt (or other prompt guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1115, a noise map is initialized that includes random noise. The noise map may be in a pixel space or a latent space. By initializing a media item with random noise, different variations of a media item including the content described by the prompt can be generated. At operation 1120, the system generates a media item based on the noise map, and/or tokens from the prompt (e.g., text prompt and/or visual prompt).

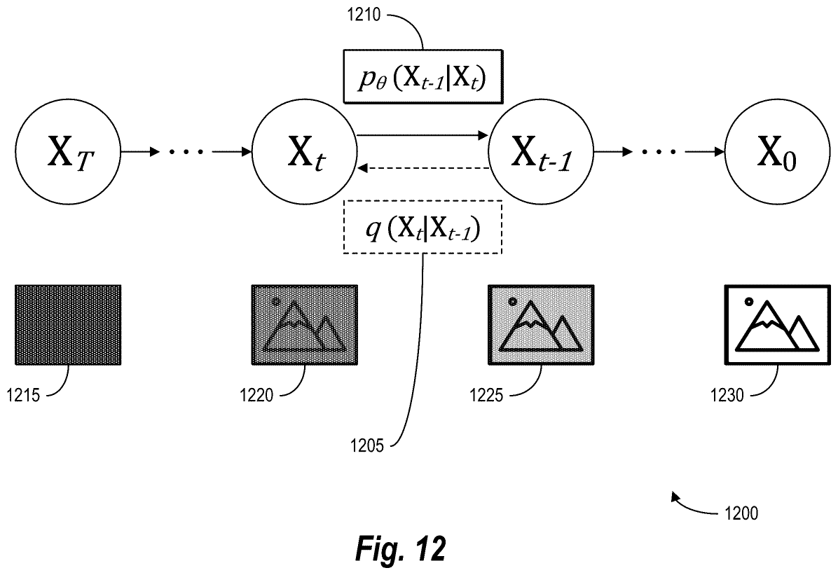

FIG. 12 shows a diffusion process 1200 according to aspects of the present disclosure. Specifically, FIG. 12 provides additional details of operating principles for a diffusion model. As described above with reference to FIG. 9, using a diffusion model can involve both a forward diffusion process 1210 for adding noise to a media item (or features in a latent space) and a reverse diffusion process 1205 for denoising the media item (or features) to obtain a denoised media item. The forward diffusion process 1210 can be represented as q(xₜ|xₜ₋₁), and the reverse diffusion process 1205 can be represented as p(xₜ₋₁|xₜ). In some cases, the forward diffusion process 1210 is used during training to generate media items with successively greater noise, and a neural network is trained to perform the reverse diffusion process 1205 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1205, the model begins with noisy data xₜ, such as a noisy media item 1215 and denoises the data to obtain the p(xₜ₋₁|xₜ). At each step t−1, the reverse diffusion process 1205 takes xₜ, such as first intermediate media item 1220, and t as input. Here, t represents a step in the sequence of transitions associated with different noise levels, The reverse diffusion process 1205 outputs xₜ₋₁, such as second intermediate media item 1225 iteratively until x_{T} reverts back to x₀, the original media item 1230. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, 1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

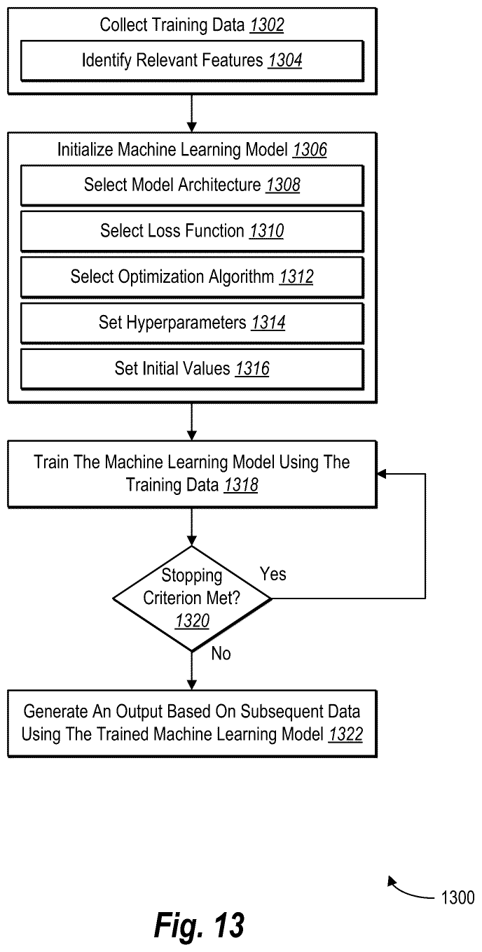

FIG. 13 is a flow diagram depicting an algorithm as a step-by-step procedure 1300 in an example implementation of operations performable for training a machine-learning model. In one or more embodiments, the procedure 1300 describes an operation of the training component described for configuring a diffusion model. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1304) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1306). Initialization of the machine-learning model includes selecting a model architecture (block 1308) to be trained. Examples of model architectures include neural networks, diffusion transformer models, transformer models, diffusion models, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm 1312 is selected that is to be used in conjunction with the loss function to optimize parameters of the machine-learning model during training, examples of which include gradient descent, stochastic gradient descent (SGD), and so forth.

Initialization of the machine-learning model further includes setting initial values (block 1316) of the machine-learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore once trained is configured to perform that task based on subsequent data received as an input and processed by the machine-learning model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

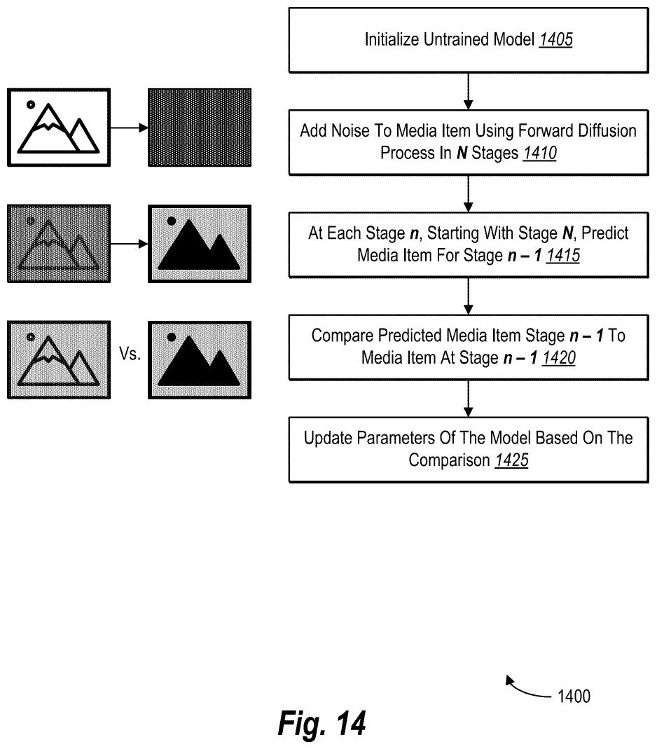

FIG. 14 shows an example of a method 1400 for training a diffusion model according to aspects of the present disclosure. In some embodiments, the method 1400 describes an operation of a training component described for configuring a diffusion model as described with reference to FIG. 16. The method 1400 represents an example for training a reverse diffusion process as described above with reference to FIG. 12. In some examples, these operations are performed by a system including a processor executing a set of codes to control functional elements of an apparatus, such as the guided diffusion model described in FIG. 9.

Additionally, or alternatively, certain processes of method 1400 may be performed using special-purpose hardware. Generally, these operations are performed according to the methods and processes described in accordance with aspects of the present disclosure. In some cases, the operations described herein are composed of various substeps or are performed in conjunction with other operations.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system adds noise to a media item using a forward diffusion process in N stages. In some cases, the forward diffusion process is a fixed process where Gaussian noise is successively added to media item. In latent diffusion models (e.g., the token space), the Gaussian noise may be successively added to features in a latent space.

At operation 1415, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1420, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1425, the system updates parameters of the model based on the comparison. For example, parameters of a U-Net may be updated using gradient descent. Time-dependent parameters of the Gaussian transitions can also be learned. However, in some embodiments, for the diffusion transformer model, the system updates parameters of each transformer block using a mean square error denoising loss.

FIG. 15 shows an example of a computing device 1500 according to aspects of the present disclosure. The computing device 1500 may be an example of the inpainting artifact correction system apparatus (e.g., an apparatus for interacting with the inpainting artifact correction system 102, which is described above). In one aspect, computing device 1500 includes processor(s) 1505, memory subsystem 1510, communication interface 1515, I/O interface 1520, user interface component(s) 1525, and channel 1530.

In one or more embodiments, computing device 1500 is an example of, or includes aspects of, the inpainting artifact correction system 102 described above. In one or more embodiments, computing device 1500 includes one or more processors 1505 that can execute instructions stored in memory subsystem 1510 to perform media generation.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In one or more embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

FIG. 16 shows an example of a inpainting artifact correction system apparatus 1600 according to aspects of the present disclosure. The inpainting artifact correction system apparatus 1600 may include an example of, or aspects of, the diffusion model described with reference to FIG. 9. In one or more embodiments, inpainting artifact correction system apparatus 1600 includes processor unit 1605, memory unit 1610, diffusion model 1615, I/O module 1620, and training component 1625. Training component 1625 updates parameters of the diffusion model 1615 stored in memory unit 1610. In some examples, the training component 1625 is located outside the inpainting artifact correction system apparatus 1600.

Processor unit 1605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1605 is configured to operate a memory array using a memory controller. In other cases, a memory controller is integrated into processor unit 1605. In some cases, processor unit 1605 is configured to execute computer-readable instructions stored in memory unit 1610 to perform various functions. In some aspects, processor unit 1605 includes special purpose components for modem processing, baseband processing, digital signal processing, or transmission processing. According to some aspects, processor unit 1605 comprises one or more processors described with reference to FIG. 15.

Memory unit 1610 includes one or more memory devices. Examples of a memory device include random access memory (RAM), read-only memory (ROM), or a hard disk.

Examples of memory devices include solid state memory and a hard disk drive. In some examples, memory is used to store computer-readable, computer-executable software including instructions that, when executed, cause at least one processor of processor unit 1605 to perform various functions described herein.

In some cases, memory unit 1610 includes a basic input/output system (BIOS) that controls basic hardware or software operations, such as an interaction with peripheral components or devices. In some cases, memory unit 1610 includes a memory controller that operates memory cells of memory unit 1610. For example, the memory controller may include a row decoder, column decoder, or both. In some cases, memory cells within memory unit 1610 store information in the form of a logical state. According to some aspects, memory unit 1610 is an example of the memory subsystem 1510 described with reference to FIG. 15.

According to some aspects, inpainting artifact correction system apparatus 1600 uses one or more processors of processor unit 1605 to execute instructions stored in memory unit 1610 to perform functions described herein. For example, the inpainting artifact correction system apparatus 1600 to perform the operations described in the aspects below.

The memory unit 1610 may include a diffusion model 1615 trained to remove noise from noised data. For example, after training, the diffusion model 1615 may perform inferencing operations as described with reference to FIGS. 9-10 to remove noise from noised data and generate media such as a modified digital image (e.g., that contains inpainted pixels).

In one or more embodiments, the diffusion model 1615 is an Artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. Specifically, each denoising block of the diffusion model 1615 can represent the connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model. Accordingly, the multi-layer perceptrons within each denoising block of the diffusion model represents various aspects of an ANN.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the diffusion model 1615 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1625 may train the diffusion model 1615. For example, parameters of the diffusion model 1615 can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion model 1615 can be used to make predictions on new, unseen data (i.e., during inference).

I/O module 1620 receives inputs from and transmits outputs of the inpainting artifact correction system apparatus 1600 to other devices or users. For example, I/O module 1620 receives inputs for the diffusion model 1615 and transmits outputs of the diffusion model 1615. According to some aspects, I/O module 1620 is an example of the I/O interface described with reference to FIG. 15.

What is claimed is:

1. A non-transitory computer-readable medium comprising instructions that, when executed by at least one processor, cause the at least one processor to perform operations comprising:
receiving an inpainting request to inpaint one or more regions in a digital image, wherein the one or more regions are indicated by a mask;
generating, utilizing a generative inpainting model, a modified digital image from the inpainting request and the digital image that includes one or more inpainted portions in place of the one or more regions; and
generating, utilizing a neural network-based refiner model, a refined digital image that corrects artifacts around borders of the one or more inpainted portions in the modified digital image.

2. The non-transitory computer-readable medium of claim 1, wherein:
generating the modified digital image comprises replacing the one or more regions indicated by the mask with inpainted pixels that conform with a background of the digital image; and
generating the modified digital image comprises generating inpainted pixels at the borders of the one or more inpainted portions with at least one of a boundary cut-off, color shifting, texture mismatches, or noise pattern mismatches.

3. The non-transitory computer-readable medium of claim 1, wherein generating the refined digital image comprises:
generating a combined image by combining the modified digital image, the digital image with the one or more regions masked, and a mask channel of the one or more regions; and
generating, utilizing a multi-channel encoder of the neural network-based refiner model, the refined digital image from the combined image by mapping inpainted pixels in the modified digital image to new pixel values.

4. The non-transitory computer-readable medium of claim 1, further comprising training the neural network-based refiner model by:
accessing ground truth digital images without inpainting artifacts; and
generating digital images with inpainting artifacts from the ground truth digital images without inpainting artifacts.

5. The non-transitory computer-readable medium of claim 4, further comprising:
generating, utilizing the neural network-based refiner model, refined training digital images to compare with the ground truth digital images without inpainting artifacts; and
modifying parameters of the neural network-based refiner model based on a comparison of the refined training digital images with the ground truth digital images without inpainting artifacts.

6. The non-transitory computer-readable medium of claim 1, further comprising training the neural network-based refiner model by:
generating, utilizing the generative inpainting model, a digital image with inpainting artifacts from a training digital image;
generating, utilizing the neural network-based refiner model, a refined training digital image from the digital image with inpainting artifacts; and
generating, utilizing a color space transformation model, a transformed version of the refined training digital image and a transformed version of a ground truth version of the training digital image.

7. The non-transitory computer-readable medium of claim 6, further comprising modifying parameters of the neural network-based refiner model based on comparing the refined training digital image with the ground truth version of the training digital image and comparing the transformed version of the refined training digital image with the transformed version of the ground truth version of the training digital image.

8. The non-transitory computer-readable medium of claim 1, wherein receiving the inpainting request comprises receiving input from a client device that indicates the mask for the one or more regions to replace the one or more regions portrayed in the digital image with content consistent with a remainder of the digital image.

9. A system comprising:
one or more memory devices; and
one or more processors coupled to the one or more memory devices that cause the system to perform operations comprising:
receiving an inpainting request to inpaint a region in a digital image, the region indicated by a mask;
generating, utilizing a generative inpainting model, a modified digital image from the inpainting request that includes inpainted pixels in the region indicated by the mask; and
generating, utilizing a neural network-based refiner model, a refined digital image that adjusts inpainting artifacts in the inpainted pixels around a border of the region in the modified digital image.

10. The system of claim 9, wherein the operations comprise:
generating the modified digital image that comprises inpainted pixels with at least one of a boundary cut-off, color shifting, texture mismatches, or noise pattern mismatches; and
generating, utilizing the neural network-based refiner model, the refined digital image that corrects at least one of the boundary cut-off, color shifting, texture mismatches, or noise pattern mismatches by mapping the inpainted pixels to new pixel values.

11. The system of claim 9, wherein receiving the inpainting request to inpaint the region in the digital image comprises:
receiving, from a client device, a sketch over the digital image that comprises the mask of the region within the digital image; and
receiving, from the client device, an indication to replace the sketch of the mask of the region in the digital image with content consistent with pixels outside of the sketch of the mask in the digital image.

12. The system of claim 9, wherein generating, utilizing the generative inpainting model, the modified digital image comprises generating the modified digital image utilizing a generative diffusion model by combining an intermediate digital image and the digital image with the region masked.

13. The system of claim 9, wherein generating the refined digital image comprises:
generating a combined image by combining the modified digital image and at least one of the digital image with the region masked or a mask channel of the region; and
generating, utilizing a multi-channel encoder of the neural network-based refiner model, the refined digital image from the combined image.

14. The system of claim 9, wherein the operations further comprise training the neural network-based refiner model by:
generating digital images with inpainting artifacts by perturbing digital images to include at least one of a boundary cut-off, color shifting, texture mismatches, or noise pattern mismatches;
generating paired data images comprising ground truth digital images without inpainting artifacts and the digital images with inpainting artifacts; and
generating, utilizing the neural network-based refiner model, refined training digital images from the digital images with inpainting artifacts.

15. The system of claim 14, further comprising:
comparing the refined training digital images with the ground truth digital images without inpainting artifacts;
generating measures of loss based on comparing the refined training digital images with the ground truth digital images without inpainting artifacts; and
modifying parameters of the neural network-based refiner model based on the measures of loss.

16. A computer-implemented method comprising:
receiving an inpainting request to inpaint one or more regions in a digital image, wherein the one or more regions are indicated by a mask;
generating, utilizing a generative inpainting model, a modified digital image from the inpainting request and the digital image that includes one or more inpainted portions in place of the one or more regions;
generating, utilizing a neural network-based refiner model, a refined digital image from the modified digital image;
generating, utilizing a color space transformation model, a transformed version of the refined digital image and a transformed version of a ground truth version of the digital image; and
modifying parameters of the neural network-based refiner model based on comparing the refined digital image with the ground truth version of the digital image and comparing the transformed version of the refined digital image with the transformed version of the ground truth version of the digital image.

17. The computer-implemented method of claim 16, further comprising:
applying perturbations to a set of digital images, wherein the perturbations comprise at least one of a boundary cut-off, color shifting, texture mismatches, or noise pattern mismatches;
accessing ground truth versions of the set of digital images without perturbations applied; and
generating paired data images comprising the set of digital images and the ground truth versions of the set of digital images without perturbations applied, wherein the paired data images comprise the modified digital image and the ground truth version of the digital image.

18. The computer-implemented method of claim 16, wherein generating the refined digital image comprises:
combining the modified digital image with a mask channel of the one or more regions in the digital image; and
generating, utilizing the neural network-based refiner model, the refined digital image that corrects artifacts around borders of the one or more regions in in the modified digital image.

19. The computer-implemented method of claim 16, wherein modifying parameters of the neural network-based refiner model comprises:
generating a first measure of reconstruction loss by comparing the refined digital image with the ground truth version of the digital image; and
modifying parameters of the neural network-based refiner model based on the first measure of reconstruction loss.

20. The computer-implemented method of claim 16, wherein modifying parameters of the neural network-based refiner model comprises:
generating a second measure of reconstruction loss by comparing the transformed version of the refined digital image with the transformed version of the ground truth version of the digital image; and
modifying parameters of the neural network-based refiner model based on the second measure of reconstruction loss.
